(19) United States
(12) Patent Application Publication
(10) Pub. No.: US 2026/0244850 A1
(43) Pub. Date: Aug. 20, 2026

(54) SELF-CREATION OF ELECTRONIC DOCUMENT FORMS

(71) Applicant: FACTIFY TECHNOLOGIES INC., Dover, DE (US)

(72) Inventors: Matan Gavish, Givat Ada (IL); Gil Asher, Binyamina (IL); Royi Noiman, Tel Aviv (IL); Rinat Freida Sorkin, Karmiel (IL)

(21) Appl. No.: 19/641,105

(22) Filed: Apr. 7, 2026

Related U.S. Application Data
(63) Continuation of application No. PCT/US2025/034169, filed on Jun. 18, 2025.
(60) Provisional application No. 63/661,534, filed on Jun. 18, 2024.
(60) Provisional application No. 63/668,068, filed on Jul. 5, 2024.
(60) Provisional application No. 63/674,793, filed on Jul. 23, 2024.
(60) Provisional application No. 63/680,061, filed on Aug. 6, 2024.
(60) Provisional application No. 63/685,234, filed on Aug. 20, 2024.
(60) Provisional application No. 63/693,173, filed on Sep. 10, 2024.
(60) Provisional application No. 63/707,992, filed on Oct. 16, 2024.
(60) Provisional application No. 63/713,200, filed on Oct. 29, 2024.
(60) Provisional application No. 63/714,009, filed on Oct. 30, 2024.
(60) Provisional application No. 63/723,471, filed on Nov. 21, 2024.
(60) Provisional application No. 63/736,568, filed on Dec. 19, 2024.
(60) Provisional application No. 63/738,639, filed on Dec. 24, 2024.
(60) Provisional application No. 63/774,949, filed on Mar. 20, 2025.
(60) Provisional application No. 63/794,007, filed on Apr. 24, 2025.
(60) Provisional application No. 63/794,564, filed on Apr. 25, 2025.
(60) Provisional application No. 63/800,869, filed on May 6, 2025.
(60) Provisional application No. 63/822,629, filed on Jun. 12, 2025.
(60) Provisional application No. 63/925,068, filed on Nov. 25, 2025.
(60) Provisional application No. 63/943,892, filed on Dec. 18, 2025.
(60) Provisional application No. 63/944,143, filed on Dec. 18, 2025.
(60) Provisional application No. 63/962,034, filed on Jan. 16, 2026.
(60) Provisional application No. 64/002,016, filed on Mar. 10, 2026.
(60) Provisional application No. 64/010,751, filed on Mar. 19, 2026.

(51) Int. Cl. G06F 40/174; G06F 16/93; G06F 40/134

(52) U.S. Cl. CPC G06F 40/174; G06F 16/93; G06F 40/134

(57) ABSTRACT

A device may receive, at an electronic document executing on a physical processor, a request to convert the electronic document into an electronic document form having read-only content and an input field. A device may analyze, by the electronic document, the request. A device may convert, by the electronic document and based on the analysis of the request, the electronic document into the form.

### PRIORITY CLAIMS TO RELATED APPLICATIONS

This application is a continuation application of and claims priority to International Patent Application No. PCT/US25/34169 filed Jun. 18, 2025, which claims priority to U.S. Provisional Patent Application Nos. 63/661,534 filed Jun. 18, 2024, 63/668,068 filed Jul. 5, 2024, 63/674,793 filed Jul. 23, 2024, 63/680,061 filed Aug. 6, 2024, 63/685,234 filed Aug. 20, 2024, 63/693,173 filed Sep. 10, 2024, U.S. 63/707,992, filed Oct. 16, 2024, U.S. 63/713,200, filed Oct. 29, 2024, U.S. 63/714,009 filed Oct. 30, 2024, U.S. 63/723,471 filed Nov. 21, 2024, U.S. 63/736,568, filed Dec. 19, 2024, U.S. 63/738,639, filed Dec. 24, 2024, U.S. 63/774,949, filed Mar. 20, 2025, U.S. 63/794,007, filed Apr. 24, 2025, U.S. 63/794,564, filed Apr. 25, 2025, U.S. 63/800,869, filed May 6, 2025, and 63/822,629 filed Jun. 12, 2025, each of which this application claims benefit to and priority to, and each of which are incorporated herein in their entirety by these references. This application also claims priority to and benefit of U.S. Provisional Patent Application Nos. 63/925,068, filed Nov. 25, 2025, 63/943,892, filed Dec. 12, 2025, 63/944,143, filed Dec. 12, 2025, 63/962,034, filed Jan. 16, 2026, 64/002,016, filed Mar. 10, 2026, and 64/010,751, filed Mar. 19, 2026, each of which are incorporated herein in their entirety by these references.

### BACKGROUND

In the modern digital era, electronic documents have become essential for information exchange, collaboration, and record-keeping across industries. Widely used formats such as PDFs, Word documents, and spreadsheets are integral to creating, sharing, and storing data. However, the static nature of these documents often limits their functionality, particularly in scenarios requiring dynamic interaction, secure access, and controlled modification. Traditional document formats lack the ability to adapt to user-specific needs or enforce granular access controls, leading to inefficiencies and security vulnerabilities. A common challenge arises when documents need to be shared with multiple parties while maintaining strict control over their content. For example, a legal contract may require certain sections to be read-only while allowing specific fields to be filled out by the recipient. Similarly, forms used in business processes, such as applications, surveys, or invoices, often need to combine immutable content with editable fields. Current solutions rely on external tools or manual processes, such as using PDF editors to create fillable forms or employing third-party platforms to manage document workflows. These approaches are cumbersome, error-prone, and often fail to provide seamless integration with the document itself.

Existing systems also lack the ability to dynamically analyze and transform documents based on user requests or contextual requirements. For instance, converting a document into a form with read-only content and input fields typically requires pre-configured templates or manual intervention, which can be time-consuming and inflexible. Moreover, these processes often fail to ensure the integrity and security of the document during and after the transformation. The need for a more intelligent and autonomous solution is evident. A system that enables electronic documents to self-transform based on user requests, while maintaining control over their content and structure, would address these challenges. Such a system would eliminate the reliance on external tools, streamline workflows, and enhance document security and usability.

### SUMMARY

In some aspects, the techniques described herein relate to a method including: receiving, at an electronic document executing on a physical processor, a request to convert the electronic document into a form having read-only content and an input field; analyzing, by the electronic document, the request; and converting, by the electronic document and based on the analysis of the request, the electronic document into the form.

In some aspects, the techniques described herein relate to a system including: at least one physical processor; physical memory including computer-executable instructions that, when executed by the physical processor, cause the physical processor to: receive, at an electronic document executing on a physical processor, a request to convert the electronic document into a form having read-only content and an input field; analyze, by the electronic document, the request; and convert, by the electronic document and based on the analysis of the request, the electronic document into the form.

In some aspects, the techniques described herein relate to a non-transitory computer-readable medium including computer-executable instructions that, when executed by at least one of one or more processors of a computing device, cause the computing device to: receive, at an electronic document executing on a physical processor, a request to convert the electronic document into a form having read-only content and an input field; analyze, by the electronic document, the request; and convert, by the electronic document and based on the analysis of the request, the electronic document into the form.

These and other features will be more clearly understood from the following detailed description taken in conjunction with the accompanying drawings and claims.

### BRIEF DESCRIPTION OF THE DRAWINGS

The accompanying drawings illustrate a number of exemplary embodiments and are a part of the specification. Together with the following description, these drawings demonstrate and explain various principles of the present disclosure.

FIG. 1 is a block diagram of a system for converting an electronic document into an electronic document form according to some embodiments of this disclosure.

FIG. 2 is a system diagram of a networked environment for accessing an electronic document and the electronic document form according to some embodiments of this disclosure.

FIG. 3 is a flowchart of a method for receiving a request, analyzing the request, and converting the electronic document into the electronic document form according to some embodiments of this disclosure.

FIG. 4 is a user interface depicting a form template presented in a viewer for processing into the electronic document form according to some embodiments of this disclosure.

FIG. 5 is a user interface depicting the electronic document form with an input field for receiving user input according to some embodiments of this disclosure.

FIG. 6 is a user interface depicting the electronic document form with an additional input field for receiving user input according to some embodiments of this disclosure.

FIG. 7 is a user interface depicting the electronic document form with entered user input in an input field according to some embodiments of this disclosure.

Throughout the drawings, identical reference characters and descriptions indicate similar, but not necessarily identical, elements. While the exemplary embodiments described herein are susceptible to various modifications and alternative forms, specific embodiments have been shown by way of example in the drawings and will be described in detail herein. However, the exemplary embodiments described herein are not intended to be limited to the particular forms disclosed. Rather, the present disclosure covers all modifications, equivalents, and alternatives falling within the scope of the appended claims.

### DETAILED DESCRIPTION OF EXEMPLARY EMBODIMENTS

Creating forms in traditional electronic document formats, such as PDFs, Word documents, and spreadsheets, is often a cumbersome and inefficient process. While these formats are widely used for their ability to preserve layout and structure, they lack inherent functionality for dynamic interaction and customization. For example, when a user needs to create a fillable form in a PDF, the process typically involves using specialized software, such as Adobe Acrobat, to manually define input fields, specify their properties, and ensure proper alignment with the document's content. This process is not only time-consuming but also prone to errors, especially when dealing with complex layouts or large documents. Additionally, the tools required for such tasks are often expensive, require significant training to use effectively, and are not universally accessible to all users. Even after the form is created, sharing and managing it can be challenging, as traditional formats do not provide mechanisms for tracking user interactions or ensuring the security of the document's content.

The limitations of traditional electronic documents become even more apparent in scenarios requiring dynamic customization or granular access control. For instance, a legal contract may need certain sections to be read-only while allowing specific fields to be editable by the recipient. Achieving this level of control in a PDF typically requires pre-configured templates or manual intervention, which can be inflexible and fail to adapt to varying user needs. Similarly, forms used in business processes, such as applications, surveys, or invoices, often require a combination of immutable content and editable fields. Traditional formats do not inherently support this functionality, forcing users to rely on external tools or platforms to manage workflows. These approaches introduce additional complexity, increase the risk of errors, and often fail to provide seamless integration with the document itself. Moreover, once a form is created, there is no guarantee of its security or integrity, as traditional formats do not offer built-in mechanisms for preventing unauthorized modifications or ensuring compliance with access restrictions.

The process of creating forms in traditional formats also lacks scalability and adaptability. For example, if a user needs to create multiple forms with similar structures but different content, they must either duplicate the original form and manually update each instance or rely on external automation tools. Both options are inefficient and fail to leverage the potential of modern computing systems to streamline repetitive tasks. Furthermore, traditional formats do not support real-time collaboration or synchronization, making it difficult for multiple users to work on the same form simultaneously. This limitation is particularly problematic in scenarios where forms need to be updated dynamically based on user input or external data sources. The static nature of traditional formats prevents them from adapting to changing requirements, leading to inefficiencies and delays in workflows.

The disclosure and creation of smart documents that can autonomously convert themselves into forms addresses these challenges and offers significant advantages over traditional formats. A smart document is designed to embed intelligence within itself, enabling it to analyze user requests and dynamically transform its structure without requiring external tools or manual intervention. For example, when a user requests to convert a document into a form, the smart document can automatically identify sections that should be read-only and create input fields in appropriate locations. This eliminates the need for specialized software and reduces the time and effort required to create forms. Additionally, the smart document can ensure the integrity and security of its content during and after the transformation process, providing built-in mechanisms for access control and preventing unauthorized modifications.

One of the advantages of smart documents is their ability to adapt to varying user needs and contextual requirements. Unlike traditional formats, which rely on static templates, smart documents can dynamically analyze the context of a request and customize their structure accordingly. For instance, a smart document can create different versions of a form based on the user's role or security clearance, ensuring that each recipient sees only the content they are authorized to access. This level of personalization is particularly valuable in scenarios involving sensitive information, such as legal contracts or financial reports. Moreover, smart documents can integrate seamlessly with external systems, enabling real-time synchronization and collaboration. For example, multiple users can fill out different sections of a form simultaneously, with changes reflected instantly across all devices. This capability eliminates the need for fragmented copies and ensures consistency in workflows.

Another advantage of smart documents is their ability to streamline repetitive tasks and enhance scalability. For example, if a user needs to create multiple forms with similar structures, the smart document can automate the process by generating forms based on predefined rules or templates. This reduces the risk of errors and significantly improves efficiency. Additionally, smart documents can leverage external data sources to pre-fill input fields or provide contextual information, further simplifying the process of creating and managing forms. For instance, a smart document can automatically populate fields with data from a database or API, ensuring accuracy and reducing the need for manual input. This capability is particularly useful in scenarios involving large-scale data collection or complex workflows.

The security and integrity of smart documents are also superior to those of traditional formats. By embedding intelligence within the document itself, smart documents can enforce access controls and track user interactions in real-time. For example, a smart document can prevent unauthorized users from accessing or modifying its content, ensuring compliance with security policies and legal requirements. Additionally, smart documents can provide detailed logs of user interactions, enabling administrators to monitor and audit workflows effectively. This level of control is not possible with traditional formats, which rely on external systems to manage security and access.

In conclusion, the process of creating forms in traditional electronic document formats is clunky, inefficient, and fraught with limitations. The reliance on external tools, manual intervention, and static templates makes it difficult to achieve dynamic interaction, granular access control, and scalability. Smart documents that can autonomously convert themselves into forms offer a transformative solution to these challenges. By embedding intelligence within the document itself, smart documents enable dynamic customization, real-time collaboration, and enhanced security, while significantly reducing the time and effort required to create and manage forms. This innovation represents a paradigm shift in document management, providing a robust and efficient alternative to traditional formats.

Legacy documents, such as PDFs, Word files, JPEGs, and MP4s, are static formats that lack dynamic, interactive, or intelligent features. These formats are widely used in existing workflows but are inherently limited in their ability to adapt to modern requirements, such as dynamic content rendering or embedded intelligence. The entry page concept addresses the challenge of transitioning from these legacy formats to advanced factified documents by acting as a bridge. An entry page is a representation of the factified document within the constraints of a legacy format, designed to guide users toward accessing the full features of the factified document while maintaining compatibility with legacy systems. For example, a PDF entry page can display a static cover page with instructions or a QR code that directs users to the dynamic factified document, ensuring backward compatibility while introducing users to the new paradigm.

The entry page solves the critical problem of integrating factified documents into legacy workflows, such as email attachments, customer portals, or fax transmissions. It allows the same file to be opened in both legacy and factified document readers, providing a static experience in traditional systems and a dynamic experience in advanced readers. By embedding lightweight mechanisms such as QR codes, URLs, and invisible watermarks, the entry page ensures secure linkage to the original factified document, reducing duplication and tampering risks. This approach promotes adoption by educating users about the benefits of factified documents while ensuring universal compatibility. In summary, the entry page is a transformative innovation that bridges the gap between legacy systems and the advanced capabilities of factified documents, enabling seamless integration and enhancing document security and usability.

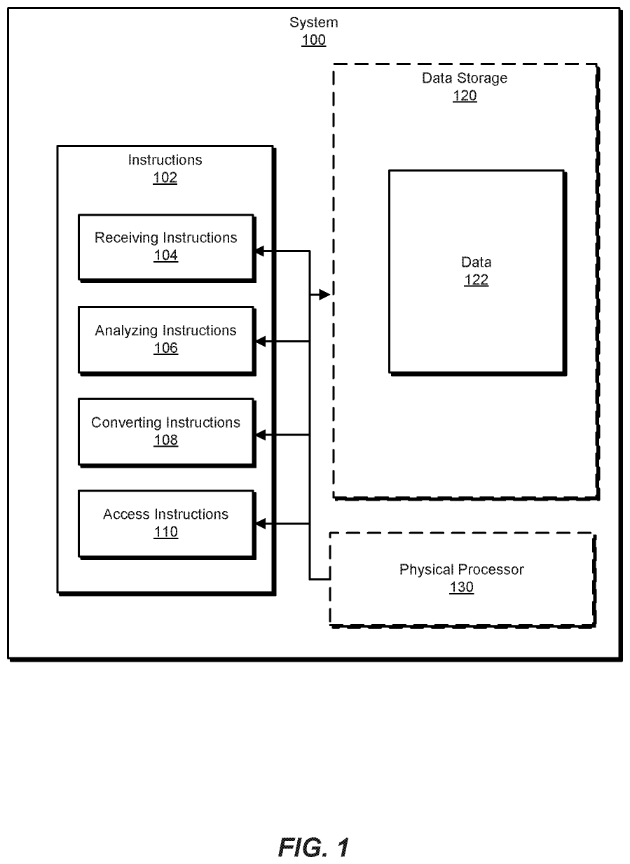

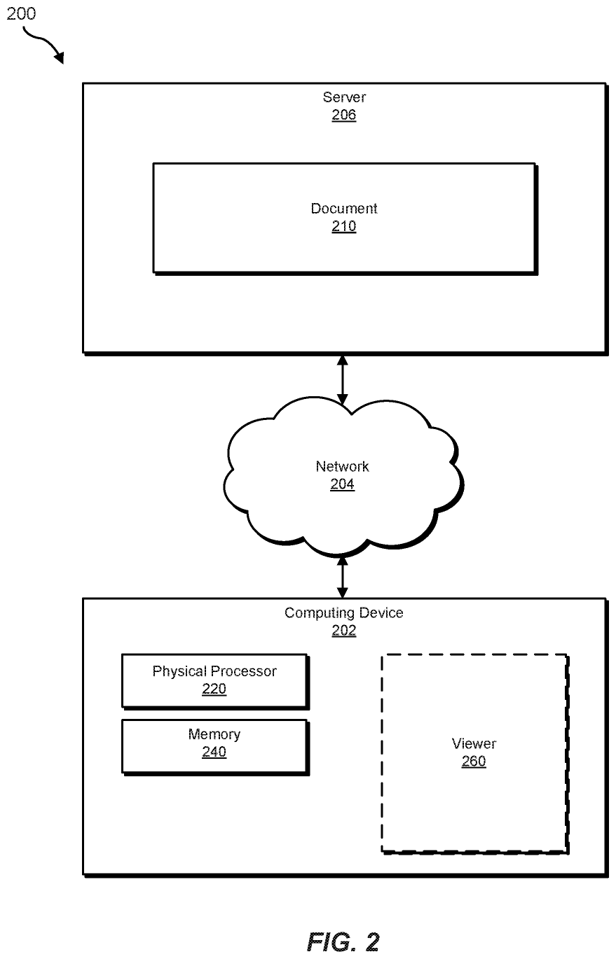

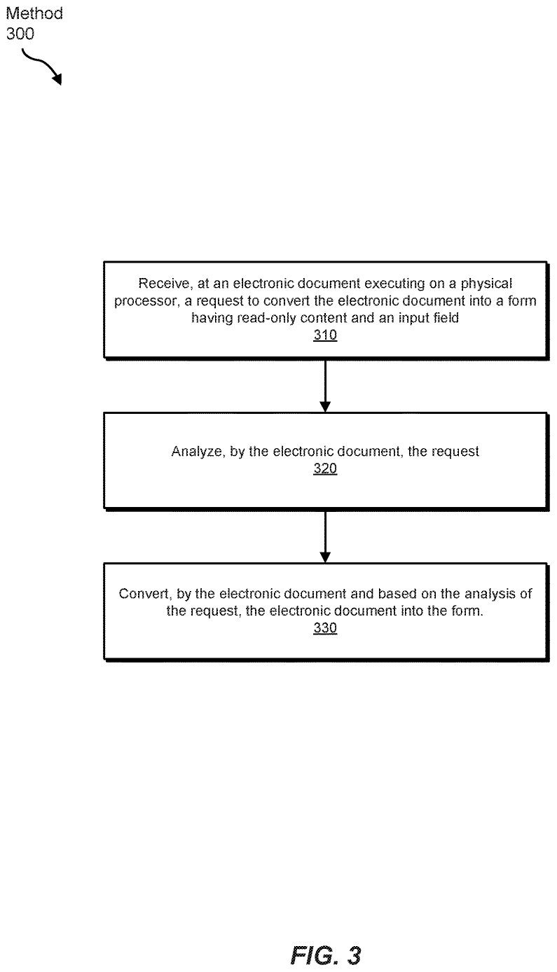

FIGS. 1-3 illustrate various aspects of the system and method for dynamically transforming electronic documents into forms with read-only content and input fields. FIG. 1 provides a block diagram of the system architecture, highlighting key components such as the physical processor, data storage, and instructions for receiving, analyzing, and converting user requests. FIG. 2 depicts the networked environment in which the system operates, including the server, computing device, and viewer, which collectively enable secure access and interaction with the document. FIG. 3 presents a flowchart of the method, detailing the steps of receiving a request at the electronic document, analyzing the request, and converting the document into a form based on the analysis. Together, these figures demonstrate the technical framework and operational flow of the invention, showcasing its ability to autonomously transform electronic documents into interactive forms while maintaining security and adaptability.

FIG. 1 illustrates a system 100 for dynamically transforming electronic documents into forms with read-only content and input fields. The system 100 comprises instructions 102, data storage 120, and a physical processor 130. The instructions 102 include receiving instructions 104, analyzing instructions 106, converting instructions 108, and access instructions 110. The data storage 120 contains data 122, which is utilized by the instructions 102 during the transformation process.

The instructions 102 are a set of computer-executable instructions that govern the operation of the system 100. The receiving instructions 104 are responsible for receiving user requests to convert an electronic document into a form. These requests may specify the desired structure of the form, such as the inclusion of read-only content and input fields. The analyzing instructions 106 analyze the received requests to determine the appropriate modifications to the electronic document. This analysis may involve identifying sections of the document intended to remain immutable and determining the placement and properties of input fields.

The converting instructions 108 execute the transformation of the electronic document based on the analysis performed by the analyzing instructions 106. This transformation includes creating the form with the specified read-only content and input fields, ensuring that the document adheres to the user's requirements. The access instructions 110 manage access control and security during and after the transformation process. These instructions may enforce restrictions on who can view or modify the form and ensure compliance with predefined conditions.

The data storage 120 serves as a repository for maintaining data 122 associated with the operation of the system 100. The data 122 may encompass user requests, contextual information, or external data sources utilized to pre-fill input fields or tailor the form. The physical processor 130 carries out the instructions 102, allowing the system 100 to perform functions in an efficient and self-directed manner. The physical processor 130 engages with the data storage 120 to access and process the data 122 as required.

In some examples, the data of a self-determinative document can include two distinct components: content 124 and metadata 126, each serving a unique purpose in the document's functionality and lifecycle. Content 124 refers to the core information of the document, such as text, images, tables, or other embedded elements that constitute the primary substance of the document. This content is immutable, meaning it cannot be altered once the document has been finalized or authenticated. The immutability of content 124 ensures the integrity and trustworthiness of the document, making it suitable for applications where the original state of the document must be preserved, such as legal agreements, financial reports, or medical records.

On the other hand, metadata 126 represents supplementary information about the document, such as timestamps, user interactions, access logs, version history, or contextual details. Unlike the immutable content, metadata 126 is mutable and can be updated or modified as the document evolves. For example, metadata can record the identity of users who accessed the document, the time and date of interactions, or the addition of comments or annotations. This mutability allows the document to dynamically track its lifecycle and provide real-time insights into its usage and provenance. By separating immutable content from mutable metadata, the document achieves a balance between preserving its core integrity and enabling flexibility for operational and contextual updates. This dual structure ensures that the document remains both reliable and adaptable, meeting the needs of secure and dynamic digital environments.

Metadata plays a central role in the functionality and transformative potential of smart documents (i.e., documents that are digital infrastructure). It provides a structured, machine-readable layer of information that goes beyond the visual representation of a document, enabling advanced computational interactions, dynamic workflows, and granular access control. Metadata can be categorized into several distinct types, each serving a unique purpose in enhancing the utility and intelligence of a document. These categories include process metadata, semantic metadata, and content-related metadata, among others. Below is a detailed explanation of these metadata types, with examples drawn from the discussion.

Process metadata captures the history and lifecycle of a document, recording every action, interaction, and workflow the document has undergone. This type of metadata serves as an audit trail, providing a comprehensive record of the document's journey and the processes it has been part of. For example, process metadata might include timestamps for when the document was created, edited, shared, or signed. It could also log the identities of users who accessed the document, the nature of their interactions (e.g., viewing, commenting, or editing), and any changes made to the document's content or metadata.

Semantic metadata describes the intrinsic characteristics of a document, answering the question of “what the document is” rather than “what the document contains.” This type of metadata includes information about the document's type, ownership, and categorical classification. For example, semantic metadata might indicate that a document is an NDA (Non-Disclosure Agreement), a marketing presentation, or a financial report. It might also specify the document's owner, such as the individual or organization responsible for its creation and management.

Semantic metadata is particularly useful for organizing and categorizing documents within a system. For instance, in an enterprise setting, semantic metadata can be used to group all contracts under a “Legal Documents” category, all invoices under a “Finance Documents” category, and all marketing materials under a “Marketing Documents” category. This categorization enables efficient search and retrieval, as users can query the system to find all documents of a specific type or category.

Content-related metadata provides a structured representation of the document's content, breaking it down into machine-readable elements such as paragraphs, headings, tables, and images. This type of metadata enables advanced computational interactions with the document, such as semantic analysis, automated workflows, and dynamic rendering.

The physical processor 130 is a hardware component that executes the instructions 102 embedded within the document 100. The physical processor 130 enables the document 100 to perform functions such as detecting signing actions, recording signatures, and managing the lifecycle of the document. This integration of hardware and software allows the document 100 to operate independently, adapting to various user environments and workflows.

An electronic document with embedded computer-executable code, which is also referred to herein as a smart electronic document, generally refers to a type of electronic document embedded with intelligence that enables it to autonomously monitor, record, and manage events associated with its lifecycle, access, and interactions. Unlike traditional documents, which depend on external systems or manual input to track changes and interactions, smart electronic documents are designed to independently identify and log activities such as access attempts, modifications, and interactions with other documents or systems.

The embedded intelligence within a smart electronic document allows it to maintain a detailed audit trail, offering insights into who accessed the document, when it was accessed, and what actions were performed. This capability is invaluable for ensuring compliance with regulatory requirements and organizational policies, as it provides a reliable and tamper-proof record of all document-related activities.

Smart electronic documents also enhance security by dynamically managing access permissions through mechanisms such as role-based access control, encryption, and multi-factor authentication. These documents ensure that only authorized users can view or modify their content. By transforming documents into active entities capable of self-monitoring and self-regulation, organizations can significantly reduce the risk of unauthorized access and data breaches while streamlining document management processes and maintaining data integrity. A smart electronic document is composed of code (i.e., intelligence), content, and metadata, which together enable its autonomous functionalities.

The attributes of a smart electronic document are multifaceted and address one or more of the limitations of traditional document management systems. For example, a smart electronic document is uniquely addressable, meaning it has a permanent and immutable identifier that distinguishes it from all other documents. This identifier ensures that the document can be reliably accessed and referenced, regardless of its location. Additionally, the document is equipped with machine-readable metadata that captures detailed information about its interactions, such as timestamps, user credentials, geolocation data, and the nature of the interaction. This metadata is not only comprehensive but also structured in a way that supports automated processing and analysis, enabling advanced functionalities such as real-time auditing and compliance verification.

Another attribute of a smart electronic document is its ability to maintain version control. When changes need to be made to the document, a new uniquely addressable version is created, rather than altering the original document. This approach preserves the integrity of the original document while providing a clear record of its evolution. Each version is assigned its own unique identifier, ensuring that it can be independently accessed and verified. The relationship between versions is also recorded, creating a hierarchical structure that allows users to trace the document's history and understand the context of each modification. For example, if a contract is updated to include new terms, the updated version will reference the original version, enabling auditors to compare the two and verify the changes.

The creation of new versions is governed by strict rules and cryptographic mechanisms to ensure authenticity and prevent unauthorized modifications. When a user or system initiates a change, the smart electronic document generates a cryptographic signature that validates the modification and ties it to the new version. This signature is stored as part of the document's metadata, providing a tamper-proof record of the change. Additionally, the document's embedded intelligence ensures that all changes are logged in its audit trail, capturing details such as who made the change, when it was made, and why it was made. This level of detail not only supports transparency but also enhances security by making it virtually impossible to alter the document without leaving a trace.

In some examples, the immutability of the content in a smart electronic document is a foundational characteristic that ensures the integrity, reliability, and trustworthiness of the document throughout its lifecycle. This immutability is achieved through a combination of technical mechanisms and design principles, which are explained below.

The “content” of a smart electronic document refers to the core information that constitutes the document, such as text, images, tables, or other embedded elements. This content is distinct from metadata (which provides supplementary information about the document, such as timestamps, user interactions, and version history) and executable code (which enables the document's intelligent functionalities). The immutability applies specifically to the content, ensuring that it remains unchanged once the document is finalized or authenticated.

To ensure immutability, the content of a smart electronic document can be cryptographically hashed at the time of its creation or finalization. A cryptographic hash is a unique, fixed-length string generated from the content using a hashing algorithm (e.g., SHA-256). This hash acts as a digital fingerprint of the content. If even a single character or pixel in the content is altered, the hash will change, making it immediately evident that the content has been tampered with.

Any system or user accessing the document can verify its integrity by recalculating the hash and comparing it to the original hash stored in the document's metadata. If the hashes match, the content is confirmed to be unchanged.

In cases where changes to the document are necessary (e.g., updates or amendments), the smart electronic document does not alter the original content. Instead, it creates a new version of the document with its own unique identifier and cryptographic hash. The original version remains intact and accessible, ensuring that the history of the document is preserved. Each version of the document is uniquely addressable and linked to the previous versions, creating a hierarchical structure that allows users to trace the evolution of the document. This approach ensures that the original content is never overwritten or lost.

In some embodiments, the smart electronic document may leverage distributed ledger technology to ensure immutability. The content and its associated hash can be recorded on a distributed ledger, where each entry is cryptographically secured and immutable. This approach provides an additional layer of protection, as the distributed ledger ensures that the content cannot be altered without consensus from the network.

The smart electronic document separates its content from other mutable elements, such as metadata and executable code. While metadata and code can be updated to reflect new interactions or functionalities, the content layer remains fixed and unchangeable. This separation ensures that the core information of the document is preserved, even as the document evolves in other ways.

The smart electronic document can provide transparency to users by enabling them to verify the authenticity and integrity of the content at any time. This transparency is achieved through audit trails and visual indicators, ensuring that users can trust the document's reliability and security.

In some embodiments, the system 100 may operate in a networked environment 204, allowing multiple users to interact with the electronic document simultaneously. The system 100 may also integrate with external systems, such as a server 206, to enhance operational capabilities, such as retrieving data from APIs or databases to populate input fields dynamically. This integration supports the adaptability of the system 100 to accommodate varying user needs and contextual requirements.

FIG. 2 illustrates a networked environment 200 for enabling the dynamic transformation of electronic documents into forms with read-only content and input fields. The networked environment 200 comprises a server 206, a document 210, a network 204, a computing device 202, a physical processor 220, memory 240, and a viewer 260.

The server 206 is a computing system that hosts the document 210, which is an electronic file capable of being dynamically transformed into a form. The server 206 facilitates the storage, management, and distribution of the document 210, ensuring secure access and interaction with the electronic file. The document 210 may include embedded instructions that enable the electronic file to receive user requests, analyze those requests, and autonomously transform its structure into a form with read-only content and input fields.

The network 204 connects the server 206 to the computing device 202, enabling communication and data exchange between these components. The network 204 may be implemented as a local area network (LAN), wide area network (WAN), or the Internet, and supports the transmission of user requests and document data between the server 206 and the computing device 202.

The computing device 202 is a user-operated device that interacts with the document 210 via the network 204. The computing device 202 comprises a physical processor 220, memory 240, and a viewer 260. The physical processor 220 executes computer-readable instructions stored in the memory 240, enabling the computing device 202 to perform operations such as sending user requests to the server 206, receiving transformed documents, and displaying the document content.

The memory 240 stores data and instructions necessary for the operation of the computing device 202. This includes instructions for interacting with the server 206, processing user input, and rendering the document 210 in the viewer 260. The memory 240 may also store temporary data related to the transformation process, such as user preferences or contextual information.

The viewer 260 is a software application or interface on the computing device 202 that displays the document 210 to the user. The viewer 260 enables the user to interact with the document, such as filling input fields, reviewing read-only content, or submitting completed forms. The viewer 260 may also provide tools for offline access and collaboration, ensuring that the document remains functional even in the absence of network connectivity.

In some embodiments, the networked environment 200 may support real-time collaboration, allowing multiple users to interact with the document 210 simultaneously. The server 206 may coordinate these interactions, ensuring that changes made by one user are reflected across all connected devices. This functionality improves the adaptability and usability of the document 210, making the document appropriate for a broad range of applications.

An electronic document with embedded computer-executable code, which is also referred to herein as a smart electronic document, generally refers to a type of electronic document embedded with intelligence that enables it to autonomously monitor, record, and manage events associated with its lifecycle, access, and interactions. Unlike traditional documents, which depend on external systems or manual input to track changes and interactions, smart electronic documents are designed to independently identify and log activities such as access attempts, modifications, and interactions with other documents or systems.

The embedded intelligence within a smart electronic document allows it to maintain a detailed audit trail, offering insights into who accessed the document, when it was accessed, and what actions were performed. This capability is invaluable for ensuring compliance with regulatory requirements and organizational policies, as it provides a reliable and tamper-proof record of all document-related activities.

Smart electronic documents also enhance security by dynamically managing access permissions through mechanisms such as role-based access control, encryption, and multi-factor authentication. These documents ensure that only authorized users can view or modify their content. By transforming documents into active entities capable of self-monitoring and self-regulation, organizations can significantly reduce the risk of unauthorized access and data breaches while streamlining document management processes and maintaining data integrity. A smart electronic document is composed of code (i.e., intelligence), content, and metadata, which together enable its autonomous functionalities.

The attributes of a smart electronic document are multifaceted and address one or more of the limitations of traditional document management systems. For example, a smart electronic document is uniquely addressable, meaning it has a permanent and immutable identifier that distinguishes it from all other documents. This identifier ensures that the document can be reliably accessed and referenced, regardless of its location. Additionally, the document is equipped with machine-readable metadata that captures detailed information about its interactions, such as timestamps, user credentials, geolocation data, and the nature of the interaction. This metadata is not only comprehensive but also structured in a way that supports automated processing and analysis, enabling advanced functionalities such as real-time auditing and compliance verification.

Another attribute of a smart electronic document is its ability to maintain version control. When changes need to be made to the document, a new uniquely addressable version is created, rather than altering the original document. This approach preserves the integrity of the original document while providing a clear record of its evolution. Each version is assigned its own unique identifier, ensuring that it can be independently accessed and verified. The relationship between versions is also recorded, creating a hierarchical structure that allows users to trace the document's history and understand the context of each modification. For example, if a contract is updated to include new terms, the updated version will reference the original version, enabling auditors to compare the two and verify the changes.

The creation of new versions is governed by strict rules and cryptographic mechanisms to ensure authenticity and prevent unauthorized modifications. When a user or system initiates a change, the smart electronic document generates a cryptographic signature that validates the modification and ties it to the new version. This signature is stored as part of the document's metadata, providing a tamper-proof record of the change. Additionally, the document's embedded intelligence ensures that all changes are logged in its audit trail, capturing details such as who made the change, when it was made, and why it was made. This level of detail not only supports transparency but also enhances security by making it virtually impossible to alter the document without leaving a trace.

In some examples, the immutability of the content in a smart electronic document is a foundational characteristic that ensures the integrity, reliability, and trustworthiness of the document throughout its lifecycle. This immutability is achieved through a combination of technical mechanisms and design principles, which are explained below.

The “content” of a smart electronic document refers to the core information that constitutes the document, such as text, images, tables, or other embedded elements. This content is distinct from metadata (which provides supplementary information about the document, such as timestamps, user interactions, and version history) and executable code (which enables the document's intelligent functionalities). The immutability applies specifically to the content, ensuring that it remains unchanged once the document is finalized or authenticated.

To ensure immutability, the content of a smart electronic document can be cryptographically hashed at the time of its creation or finalization. A cryptographic hash is a unique, fixed-length string generated from the content using a hashing algorithm (e.g., SHA-256). This hash acts as a digital fingerprint of the content. If even a single character or pixel in the content is altered, the hash will change, making it immediately evident that the content has been tampered with.

Any system or user accessing the document can verify its integrity by recalculating the hash and comparing it to the original hash stored in the document's metadata. If the hashes match, the content is confirmed to be unchanged.

In cases where changes to the document are necessary (e.g., updates or amendments), the smart electronic document does not alter the original content. Instead, it creates a new version of the document with its own unique identifier and cryptographic hash. The original version remains intact and accessible, ensuring that the history of the document is preserved. Each version of the document is uniquely addressable and linked to the previous versions, creating a hierarchical structure that allows users to trace the evolution of the document. This approach ensures that the original content is never overwritten or lost.

In some embodiments, the smart electronic document may leverage distributed ledger technology to ensure immutability. The content and its associated hash can be recorded on a distributed ledger, where each entry is cryptographically secured and immutable. This approach provides an additional layer of protection, as the distributed ledger ensures that the content cannot be altered without consensus from the network.

The smart electronic document separates its content from other mutable elements, such as metadata and executable code. While metadata and code can be updated to reflect new interactions or functionalities, the content layer remains fixed and unchangeable. This separation ensures that the core information of the document is preserved, even as the document evolves in other ways.

The smart electronic document can provide transparency to users by enabling them to verify the authenticity and integrity of the content at any time. This transparency is achieved through audit trails and visual indicators, ensuring that users can trust the document's reliability and security.

FIG. 3 presents a flowchart illustrating the method for dynamically transforming an electronic document into an electronic document form with read-only content and input fields. The flowchart outlines the sequential steps performed by the electronic document, including receiving a user request to convert the document, analyzing the request to determine the necessary modifications, and executing the transformation based on the analysis. This figure highlights the autonomous capabilities of the electronic document, showcasing its ability to process user input, adapt its structure, and ensure the integrity of the resulting form. The depicted method demonstrates how the system simplifies the creation of interactive forms while maintaining security, consistency, and adaptability to varying user needs.

Step 310 involves receiving, at an electronic document executing on a physical processor, a request to convert the electronic document into a form with read-only content and input fields. This step is critical as it initiates the transformation process and sets the foundation for the subsequent analysis and conversion steps. The request can be received in various ways, depending on the user's interaction with the document and the system's configuration. For example, the user may interact with a graphical user interface (GUI) within a document viewer, selecting an option such as “Convert to Form” or “Create Fillable Form.” Alternatively, the request may be triggered programmatically, such as through an API call from an external application that integrates with the electronic document system. In some cases, the request may include specific parameters, such as identifying sections of the document to remain read-only or specifying the type and location of input fields to be added.

The request can also vary in complexity. For instance, a simple request might involve converting the entire document into a form with a single input field, while a more complex request could specify multiple input fields with distinct properties, such as text fields, checkboxes, dropdown menus, or signature fields. Additionally, the request may include contextual information, such as the user's role, security clearance, or intended use of the form. For example, a legal professional might request to convert a contract into a form where certain clauses are read-only and specific fields are editable for inputting party names and dates. Similarly, a business user might request to transform an invoice template into a form with pre-filled fields for company details and editable fields for item descriptions and quantities.

In some embodiments, the request may be received indirectly, such as through a workflow automation system that detects the need for a form based on predefined rules or triggers. For example, if a user uploads a document to a shared workspace, the system may automatically generate a request to convert the document into a form based on the workspace's settings or the document's metadata. Alternatively, the request may be initiated by external systems, such as a customer relationship management (CRM) platform or an enterprise resource planning (ERP) system, which requires the document to be formatted as a form for data collection or processing.

The method of receiving the request can also be tailored to accommodate different user preferences and accessibility needs. For instance, a user may issue the request via voice commands, such as saying, “Convert this document into a form with input fields for name and address.” Alternatively, the request may be submitted through a mobile application, where users can tap on specific sections of the document to designate them as input fields. In scenarios involving collaborative environments, multiple users may contribute to the request, specifying different sections of the document to be converted based on their individual roles and responsibilities.

Overall, step 310 is designed to be flexible and adaptable, ensuring that the system can accommodate a wide range of user needs and interaction methods. By receiving and processing the request effectively, the system lays the groundwork for transforming the electronic document into a secure, interactive form that meets the user's requirements.

Step 320 involves analyzing, by the electronic document, the request to convert the document into a form with read-only content and input fields. This step is pivotal as it determines the specific modifications required to transform the document based on the user's input and contextual requirements. The analysis performed by the electronic document may include identifying sections of the document that should remain immutable, determining the placement and type of input fields, and evaluating any additional parameters provided in the request. For example, if the request specifies that certain paragraphs in a legal contract should be read-only while allowing specific fields for party names and dates to be editable, the system analyzes the document's structure to locate these sections and applies the appropriate restrictions and modifications.

The analysis may also involve interpreting contextual information embedded in the request, such as the user's role, security clearance, or intended use of the form. For instance, if the request is made by a user with limited access privileges, the system may analyze the document to ensure that sensitive sections are hidden or restricted from editing. Alternatively, if the request is made by a user with administrative privileges, the system may allow broader modifications, such as adding new input fields or adjusting existing ones. In another example, a request to convert a financial report into a form may include instructions to make certain tables read-only while enabling editable fields for comments or annotations. The system analyzes the document's layout and content to identify the tables and apply the specified restrictions.

In some embodiments, the analysis may extend to external data sources or predefined templates. For example, the system may retrieve data from a database or API to pre-fill input fields based on the user's request. If the request involves creating a form for customer feedback, the system may analyze the document to identify relevant sections and dynamically generate input fields such as text boxes for comments, dropdown menus for ratings, or checkboxes for preferences. Similarly, the system may analyze the request against predefined templates to ensure consistency and compliance with organizational standards. For instance, a request to convert a job application form may be analyzed to match the structure and format of existing templates used by the organization.

The analysis may also include evaluating the document's metadata or embedded tags to determine its structure and content hierarchy. For example, if the document includes semantic tags indicating sections such as “header,” “body,” or “appendix,” the system can analyze these tags to identify areas suitable for read-only content or input fields. This approach ensures that the transformation process aligns with the document's intended layout and functionality. Additionally, the system may analyze the request for any conditional logic or formulas associated with the input fields. For instance, a request to add a formula to a field may be analyzed to ensure that the formula is correctly applied and executed when the field is filled.

In scenarios involving collaborative environments, the analysis may account for input from multiple users. For example, if different users specify sections of the document to be converted based on their roles, the system analyzes these inputs to create a form that accommodates all user requirements while maintaining consistency and security. The system may also analyze the request for potential conflicts or errors, such as overlapping input fields or contradictory restrictions, and resolve them before proceeding with the transformation.

Overall, step 320 is designed to be comprehensive and adaptable, ensuring that the electronic document can analyze and interpret a wide range of requests and contextual information. By performing this analysis effectively, the system ensures that the resulting form meets the user's requirements while maintaining the integrity, security, and usability of the document.

Step 330 involves converting, by the electronic document and based on the analysis of the request, the electronic document into a form with read-only content and input fields. This step is the culmination of the transformation process, where the document autonomously executes the modifications determined during the analysis phase to create a functional and interactive form. The conversion process may include a variety of actions, such as locking specific sections of the document to make them read-only, inserting input fields in designated areas, and applying formatting or validation rules to ensure the form meets the user's requirements.

For example, if the analysis identifies that certain paragraphs in a legal contract should remain immutable, the conversion process locks those sections, preventing any edits. Simultaneously, the system may add input fields for editable content, such as party names, dates, or signatures, ensuring these fields are appropriately placed and formatted. In another scenario, the conversion may involve creating a survey form where questions are read-only, and respondents can select answers using dropdown menus, checkboxes, or radio buttons. The system ensures that the input fields are aligned with the document's layout and are visually intuitive for the user.

The conversion process may also include applying validation rules to input fields. For instance, a field for entering a date may be configured to accept only valid date formats, while a numeric field may restrict input to specific ranges. In some cases, the system may add conditional logic to the form, such as enabling certain fields only if specific criteria are met. For example, a field for additional comments may appear only if the user selects “Other” as an answer to a preceding question. These dynamic features enhance the usability and functionality of the form, making it adaptable to varying user needs.

In some embodiments, the conversion process may involve integrating external data sources to pre-fill input fields. For example, if the form is an invoice template, the system may retrieve customer details, product information, or pricing data from a database or API and populate the relevant fields automatically. This reduces manual input and ensures accuracy, particularly in scenarios involving large-scale data collection or repetitive tasks. Similarly, the system may embed formulas or calculations within the form, such as automatically calculating totals based on quantities and unit prices entered by the user.

The conversion process may also include generating multiple versions of the form based on user roles or access privileges. For instance, a form shared with different departments in an organization may display varying levels of detail depending on the recipient's role. A manager may see all sections of the form, while a team member may only have access to specific fields relevant to their responsibilities. This level of customization ensures that the form is tailored to the needs of each user while maintaining security and access control.

In collaborative environments, the conversion process may enable real-time synchronization of the form across multiple devices and users. For example, if several users are filling out different sections of the form simultaneously, the system ensures that changes made by one user are instantly reflected for all other collaborators. This eliminates the need for fragmented copies and ensures consistency in workflows. Additionally, the system may generate a link to the form, allowing users to access and complete it online or offline, depending on their preferences.

The conversion process may also include security measures to protect the integrity of the form. For example, the system may encrypt sensitive sections of the form or apply digital signatures to ensure authenticity. It may also track user interactions, such as edits or submissions, and generate logs for auditing purposes. These features provide a robust framework for managing the form securely and ensuring compliance with organizational policies or legal requirements.

Overall, step 330 is designed to be versatile and efficient, enabling the electronic document to autonomously transform into a functional and secure form that meets the user's requirements. By executing the modifications determined during the analysis phase, the system ensures that the resulting form is intuitive, adaptable, and reliable, addressing the limitations of traditional document formats and workflows.

The method includes the capability of pre-filling input fields within the electronic document during the transformation process, enhancing efficiency and reducing the need for manual data entry. Pre-filling involves automatically populating specific input fields with relevant data based on contextual information, external data sources, or predefined rules. For example, in the case of an invoice form, the system may retrieve customer details, such as name, address, and account number, from a connected database or API and populate the corresponding fields in the form. Similarly, for a job application form, the system may pre-fill fields with information such as the company name, job title, and application deadline based on metadata embedded in the document or external templates.

This pre-filling functionality can also leverage user-specific data to personalize the form. For instance, if the form is being accessed by a registered user, the system may automatically populate fields with the user's name, email address, or other profile information stored in the system. In scenarios involving collaborative environments, pre-filling can be tailored to the role or permissions of the user. For example, a manager accessing a performance review form may see pre-filled fields with employee details and review periods, while a team member may only see fields relevant to their own input.

Pre-filling can also incorporate dynamic data from external sources to ensure accuracy and relevance. For example, a financial report form may include pre-filled fields with current stock prices or exchange rates retrieved from an online financial database. Similarly, a survey form may pre-fill demographic fields based on the user's location or preferences detected through the system. This capability not only saves time but also minimizes errors that can occur during manual data entry.

In addition to external data sources, pre-filling can utilize conditional logic to populate fields based on prior user input or system-defined rules. For instance, if a user selects a specific product category in a dropdown menu, the system may automatically populate related fields, such as product specifications or pricing details. Similarly, if a user indicates their role as a contractor, the system may pre-fill fields with standard contract terms or payment schedules relevant to contractors.

Pre-filling also supports scenarios where forms are part of a larger workflow or sequence of actions. For example, if a user completes one form in a series, the system can use the data entered in the first form to pre-fill fields in subsequent forms, ensuring consistency and reducing redundancy. This is particularly useful in applications such as onboarding processes, where multiple forms need to be completed with overlapping information.

Overall, the pre-filling functionality significantly enhances the usability and efficiency of the electronic document transformation process. By automating the population of input fields, the system reduces the burden on users, ensures accuracy, and streamlines workflows, making the resulting forms more intuitive and effective for a wide range of applications.

The method includes several advanced functionalities that enhance the usability, accessibility, and efficiency of electronic documents transformed into forms. One such functionality involves generating, by the electronic document, a link to the form. This link serves as a direct access point to the form, allowing users to interact with it without requiring additional software or manual distribution. For example, the system may generate a secure URL that can be shared via email, messaging platforms, or embedded within other systems, such as customer portals or enterprise applications. The link can be configured to include access controls, such as expiration dates, password protection, or user-specific permissions, ensuring that only authorized individuals can access the form. Alternatively, the link may be dynamic, allowing real-time updates to the form as users interact with it. For instance, in collaborative environments, the link may reflect changes made by one user instantly for all other users accessing the form. In some embodiments, the link may also integrate with external systems, such as document management platforms or workflow automation tools, enabling seamless integration into broader processes.

Another functionality involves enabling offline filling of the input field by the electronic document. This capability ensures that users can interact with the form even in the absence of an active network connection, making it particularly useful in scenarios where connectivity is limited or unreliable. For example, a field worker completing a survey in a remote location can fill out the form offline, with the system automatically synchronizing the data once connectivity is restored. Offline filling may also be beneficial for mobile users, allowing them to interact with forms on their devices without requiring constant internet access. The system may store the offline data locally on the user's device, encrypting it to ensure security until it is uploaded to the server. In some embodiments, the offline functionality may include additional features, such as local validation of input fields or the ability to save partially completed forms for later submission. This ensures that users can work efficiently without losing progress due to connectivity issues.

The method also includes the ability to determine, by the electronic document, that each input field of the form has been filled and trigger a notification indicating that the form has been completed. This feature streamlines workflows by providing real-time updates on the status of the form. For example, once all required fields are filled, the system may send a notification to the form's creator, administrator, or other relevant stakeholders, indicating that the form is ready for review or processing. The notification can be delivered through various channels, such as email, SMS, or in-app alerts, depending on user preferences. In some embodiments, the system may also trigger additional actions based on the completion status, such as automatically submitting the form to a designated recipient, generating a summary report, or initiating subsequent steps in a workflow. For instance, in a hiring process, the completion of a job application form may trigger an automated email to the HR department for review. Alternatively, the system may provide visual indicators within the form itself, such as a progress bar or completion badge, to inform users of their progress and ensure all fields are filled before submission. This functionality can also include error-checking mechanisms to validate the input and ensure compliance with predefined rules, such as requiring specific formats for dates or restricting numeric fields to certain ranges.

Together, these functionalities—link generation, offline filling, and completion notifications—significantly enhance the versatility and efficiency of electronic documents transformed into forms. They provide users with flexible access options, ensure usability in diverse environments, and streamline workflows by automating key processes, making the system adaptable to a wide range of applications and user needs.

The method includes the ability to enforce predefined conditions before allowing an input field within the electronic document to be filled, offering a robust mechanism for ensuring compliance with specific rules or requirements. This functionality begins with the electronic document receiving a request to associate a condition with an input field. The predefined condition can vary widely depending on the context and use case. For example, in a legal contract, the condition might require the user to acknowledge certain terms or sign a preliminary agreement before being allowed to fill out specific fields. In a survey form, the condition might involve selecting a particular option in a preceding question before enabling additional fields. Similarly, in a financial application, the condition could require the user to input a valid account number or meet a minimum balance threshold before being allowed to enter transaction details.

Once the condition is associated with the input field, the electronic document dynamically evaluates whether the condition has been met whenever an attempt is made to fill the field. For instance, if the condition requires the user to select “Yes” in a prior dropdown menu, the document checks the user's input and determines whether the required selection has been made. If the condition has not been satisfied, the system prevents the input field from being filled, ensuring that the user cannot bypass the predefined rules. This prevention mechanism can be implemented in various ways, such as disabling the input field, displaying an error message, or providing guidance on how to meet the condition. For example, the document might display a message stating, “Please complete Section A before entering details in this field,” or highlight the unmet condition to direct the user's attention.

In some embodiments, the predefined condition may involve external factors or data sources. For instance, the condition could require verification from an external system, such as confirming the user's identity through a connected authentication service or checking eligibility criteria against a database. For example, in a loan application form, the condition might involve verifying the user's credit score or employment status before enabling fields for loan amount and repayment terms. Alternatively, the condition could be time-based, such as requiring the user to wait until a specific date or event has occurred before filling out certain fields. For instance, a registration form for an event might prevent users from entering payment details until the registration window opens.

The system can also support complex conditional logic involving multiple criteria. For example, a condition might require the user to meet several requirements simultaneously, such as completing all mandatory fields in a prior section, providing a valid email address, and agreeing to terms and conditions. The electronic document evaluates each criterion and prevents access to the input field until all conditions are satisfied. In collaborative environments, the condition might involve actions by multiple users. For instance, a field might remain locked until a supervisor approves the preceding section or another team member completes their assigned portion of the form.

This functionality can be further enhanced by providing feedback to the user on how to meet the condition. For example, the document might display a checklist of requirements or dynamically update the interface to show progress toward meeting the condition. In some cases, the system may offer alternatives or workarounds, such as allowing the user to request an override or submit additional documentation to satisfy the condition.

Overall, the ability to enforce predefined conditions before allowing input fields to be filled adds a layer of control and security to electronic documents. By dynamically evaluating and preventing access to fields based on unmet conditions, the system ensures compliance with rules, reduces errors, and enhances the integrity of the document. This functionality is adaptable to a wide range of applications, including legal, financial, educational, and collaborative workflows, making it a versatile and valuable feature for modern document management systems.

The method includes the capability of enabling real-time synchronization of input fields across multiple devices, allowing input from one user on a first device to be displayed on a second device for another user. This functionality is particularly valuable in collaborative environments where multiple users need to interact with the same document simultaneously. For example, in a team setting, a manager filling out a budget field on their laptop can have their input instantly reflected on a team member's tablet, ensuring that everyone is working with the most up-to-date information. This eliminates the need for fragmented copies of the document and reduces the risk of discrepancies caused by outdated versions.

The synchronization process can be implemented in various ways. In one embodiment, the electronic document is hosted on a centralized server, and changes made by the first user are transmitted to the server, which then updates the document for all connected devices. Alternatively, the document may use peer-to-peer communication protocols to directly share updates between devices, reducing latency and improving efficiency in environments with limited server access. The synchronization can also be configured to occur in real-time, where updates are displayed instantaneously, or in periodic intervals, where changes are batched and transmitted at scheduled times to optimize network usage.

This functionality can be extended to support different types of input fields. For instance, text fields can display typed responses, dropdown menus can reflect selected options, and signature fields can show completed signatures. In more complex scenarios, such as collaborative editing of a legal contract, the system can highlight changes made by the first user, allowing the second user to review and approve them before they are finalized. Additionally, the system can provide visual indicators, such as color-coded highlights or timestamps, to show which user made specific changes and when.

In some embodiments, the synchronization can be tailored to user roles and permissions. For example, a supervisor may have the ability to view all input fields across devices, while a team member may only see fields relevant to their responsibilities. This ensures that sensitive information is protected while maintaining transparency and collaboration. Furthermore, the system can support conditional synchronization, where updates are only shared if certain criteria are met. For instance, input from the first user may only be displayed on the second device after it has been validated or approved by the system.

Offline scenarios can also be accommodated. If the first user enters input while offline, the system can store the changes locally and synchronize them with the second device once connectivity is restored. This ensures that collaboration is not disrupted by temporary network issues. Additionally, the system can provide conflict resolution mechanisms to handle situations where multiple users make changes to the same input field simultaneously. For example, the document may prompt users to choose between conflicting inputs or merge changes based on predefined rules.

Overall, the ability to receive input from one user and display it on another user's device enhances collaboration, reduces errors, and ensures consistency across workflows. This functionality is adaptable to a wide range of applications, including team-based projects, legal document review, financial planning, and educational settings. By enabling seamless synchronization, the system transforms electronic documents into dynamic, interactive tools that support real-time collaboration and efficient communication.

The method includes the capability of incorporating a signature field within the electronic document, enabling users to provide signatures directly within the document. This functionality is particularly valuable in scenarios requiring authentication, approval, or legal compliance, such as signing contracts, agreements, or forms. The signature field can be designed to accommodate various types of signatures, including handwritten signatures, typed signatures, or digital signatures based on cryptographic methods. For example, a user may sign a document by drawing their signature using a stylus or finger on a touchscreen device, typing their name into a designated field, or applying a secure digital signature using an RSA key pair.

The electronic document can receive the signature in multiple formats, depending on the user's preferences and the requirements of the document. For instance, a handwritten signature may be captured as an image file embedded within the document, while a typed signature may be stored as text with associated metadata, such as the time and date of signing. Digital signatures, on the other hand, provide an additional layer of security by cryptographically binding the signature to the document's content, ensuring that any subsequent modifications to the document invalidate the signature. This is particularly useful in legal and financial contexts where document integrity is critical.

In some embodiments, the signature field may include validation mechanisms to ensure the authenticity of the signature. For example, the system may require the user to authenticate their identity before signing, using methods such as password entry, biometric verification (e.g., fingerprint or facial recognition), or two-factor authentication. Additionally, the system may enforce specific formatting rules for the signature, such as requiring the user to sign within a designated area or ensuring that the signature meets predefined size and alignment criteria.

The signature field can also support conditional logic, where the field becomes accessible only after certain prerequisites are met. For instance, a user may be required to review and acknowledge specific terms and conditions before the signature field is enabled. Alternatively, the system may restrict access to the signature field based on the user's role or permissions. For example, only authorized personnel, such as a company executive or legal representative, may be allowed to sign certain sections of the document.

In collaborative environments, the signature field can facilitate multi-party signing workflows. For example, a contract may require signatures from multiple parties, each signing on their respective devices. The system can coordinate these interactions, ensuring that all signatures are captured and displayed in the document in real-time. Additionally, the system may provide visual indicators, such as timestamps or user identifiers, to track the signing process and ensure transparency.

The signature field can also integrate with external systems to enhance functionality. For instance, the system may connect to a digital signature platform, such as DocuSign or Adobe Sign, to provide additional signing options or compliance with jurisdiction-specific regulations. Alternatively, the system may store signed documents in a secure repository or transmit them to designated recipients automatically upon completion.

Overall, the inclusion of a signature field within the electronic document streamlines the signing process, enhances security, and ensures compliance with legal and organizational requirements. By offering multiple signature options, validation mechanisms, and integration capabilities, the system provides a versatile and efficient solution for managing signatures in electronic documents. This functionality is adaptable to a wide range of applications, including legal agreements, financial transactions, and administrative workflows, making it an essential feature for modern document management systems.

The method includes the capability of receiving input from a user at an input field within an electronic document, determining that the input is relevant to an additional form, and coordinating the automatic filling of a corresponding field in the additional form. This functionality streamlines workflows by reducing redundancy and ensuring consistency across multiple forms. For example, if a user enters their name and contact information into a registration form, the system can determine that this data is also relevant to a subsequent feedback form or invoice and automatically populate the corresponding fields in those forms. This eliminates the need for the user to repeatedly enter the same information, saving time and minimizing errors.

The determination of relevance can be based on various factors, such as predefined rules, metadata, or contextual analysis. For instance, the system may analyze the structure and content of the input field to identify matching fields in the additional form. If the input field is labeled “Email Address,” the system can search for fields with similar labels or attributes in other forms and establish a connection. Alternatively, the system may use metadata tags associated with the input field to identify its relevance to other forms. For example, a field tagged as “Customer ID” may automatically populate corresponding fields in forms related to billing, shipping, or customer support.

In some embodiments, the system may leverage external data sources or integration with third-party platforms to enhance the coordination process. For instance, if the user enters their company name in a form, the system may retrieve additional details, such as the company's address or tax identification number, from a connected database and populate relevant fields in other forms. Similarly, the system may use APIs to synchronize data across enterprise applications, ensuring that the input provided by the user is reflected in all associated forms and systems.

The coordination process can also include conditional logic to ensure that the input is applied appropriately. For example, the system may verify that the input meets specific criteria before populating fields in the additional form. If the user enters a phone number, the system may check that the format is valid before transferring the data. Additionally, the system may apply transformations to the input to match the requirements of the additional form. For instance, if the user enters their name in uppercase letters, the system may convert it to title case before populating the corresponding field in another form.

In collaborative environments, this functionality can be extended to support multi-user workflows. For example, if one user enters project details into a form, the system can determine that the data is relevant to forms used by other team members and automatically populate those forms. This ensures that all collaborators are working with consistent and up-to-date information, reducing the risk of miscommunication or duplication.

The system may also provide feedback to the user regarding the coordination process. For instance, the document may display a notification indicating that the input has been successfully applied to additional forms. Alternatively, the system may allow the user to review and confirm the populated fields before finalizing the process. This ensures transparency and gives the user control over the data transfer.

Overall, the ability to coordinate the filling of fields in additional forms based on user input enhances efficiency, accuracy, and consistency across workflows. By automating the transfer of relevant data, the system reduces the burden on users, minimizes errors, and ensures seamless integration between forms and systems. This functionality is adaptable to a wide range of applications, including business processes, legal workflows, and customer interactions, making it a valuable feature for modern document management systems.

The method includes the capability of identifying information from an external data source relevant to the form and using that information to automatically fill the input field within the electronic document. This functionality significantly enhances the efficiency and accuracy of form completion by reducing the need for manual data entry and ensuring that the input fields are populated with up-to-date and relevant information. For example, in the case of an invoice form, the system may retrieve customer details, such as name, address, and account number, from a connected customer relationship management (CRM) database and populate the corresponding fields automatically. Similarly, for a job application form, the system may access an external human resources database to pre-fill fields with information such as the job title, application deadline, and company name.

The identification of relevant information can be achieved through various mechanisms. For instance, the electronic document may analyze metadata associated with the input field, such as field labels or tags, to determine the type of data required. If the input field is labeled “Email Address,” the system can query external data sources for matching information and retrieve the appropriate email address. Alternatively, the system may use contextual analysis to identify relevant data. For example, if the form is part of a workflow related to a specific project, the system may retrieve project-specific details, such as budget allocations or team member names, from a project management platform.

In some embodiments, the system may leverage APIs to integrate with external data sources, enabling seamless data retrieval and synchronization. For instance, the electronic document may connect to a financial database to retrieve current stock prices or exchange rates for a financial report form. Similarly, the system may access a government database to populate fields with regulatory information, such as tax codes or compliance requirements. This integration ensures that the input fields are populated with accurate and authoritative data, reducing the risk of errors and inconsistencies.

The system can also support dynamic data retrieval based on user input or predefined rules. For example, if a user selects a specific product category in a dropdown menu, the system may query an external inventory database to retrieve product specifications, pricing details, or availability information and populate the relevant fields. Similarly, if a user enters their location, the system may access a geolocation database to pre-fill fields with local information, such as nearby service providers or applicable regional regulations.

In scenarios involving collaborative environments, the system may retrieve data from shared external sources to ensure consistency across multiple users. For example, if a team is working on a shared form, the system may access a centralized database to populate fields with team-wide information, such as project deadlines or shared resources. This ensures that all collaborators are working with the same data, reducing the risk of miscommunication or duplication.

The system may also provide feedback to the user regarding the data retrieval process. For instance, the document may display a notification indicating that the input field has been successfully populated with data from an external source. Alternatively, the system may allow the user to review and confirm the retrieved data before finalizing the process. This ensures transparency and gives the user control over the data used to populate the form.

Overall, the ability to identify and use information from external data sources to fill input fields enhances the functionality and usability of electronic documents. By automating data retrieval and integration, the system reduces the burden on users, ensures accuracy, and streamlines workflows. This capability is adaptable to a wide range of applications, including business processes, legal workflows, financial reporting, and customer interactions, making it a valuable feature for modern document management systems.

In some examples the term for refers to a canvas for collecting data serves as a versatile and dynamic tool that adapts to the needs of the user and the context in which it is employed. Unlike traditional static forms, this type of canvas is interactive, allowing users to input information in real-time while simultaneously responding to prompts or conditions embedded within the form itself. The canvas begins as a flexible structure, capable of gathering information from various sources, whether human or machine, and evolves into a binding entity once the data is finalized or validated. This transformation from an interactive state to a binding state is crucial, as it ensures the integrity and reliability of the collected data. The canvas is often associated with workflows, serving as a sub-species of tools designed to elicit specific actions or data from users. It is not limited to a single mode of interaction; rather, it affords multiple experiences tailored to the user's preferences or the nature of the task. For instance, the canvas can function as a wizard, guiding users step-by-step through a process, or as a chat-based interface, enabling conversational data collection. It can also accommodate attachments, allowing users to upload supplementary documents or files that enhance the completeness of the collected information. This adaptability makes the canvas an indispensable tool in scenarios requiring dynamic interaction and seamless integration with broader workflows.

A document that aggregates different responses and relationships functions as a centralized repository for diverse inputs, often resembling a binder in its organizational structure. This type of document is designed to synchronize data across multiple sources, ensuring consistency and coherence in the information it contains. Synchronization is a key feature, allowing the document to update in real-time as new data is added or existing data is modified. This capability is particularly valuable in collaborative environments, where multiple users may interact with the document simultaneously. The document can present data in a format accessible to humans, such as a visually intuitive layout, or make the data available for machines to fetch and process. This dual accessibility ensures that the document serves both as a human-readable record and as a machine-readable dataset, bridging the gap between manual and automated workflows. By maintaining relationships between different pieces of data, the document provides a comprehensive view of the information, enabling users to understand the context and connections between various inputs. This functionality is essential in scenarios where the document serves as a reference point for decision-making or as a record of interactions and transactions.

Some examples provide a form that knows what it wants as an intelligent entity capable of generating different experiences based on its inherent design and the context of its use. This intelligence allows the form to adapt its structure and presentation to suit the needs of the user or the task at hand. For example, the form can function as a wizard, guiding users through a series of steps in a logical sequence, or as a chat-based interface, enabling conversational data collection. It can also support phone-based interactions, providing a mobile-friendly experience that ensures accessibility across devices. The form's ability to generate different experiences is rooted in its understanding of the data it seeks to collect and the actions it aims to elicit. This adaptability makes the form a powerful tool for engaging users and ensuring the completeness and accuracy of the collected information. By offering multiple modes of interaction, the form caters to a wide range of user preferences and scenarios, enhancing its utility and effectiveness.

An empty form being filled by different people exemplifies the dual nature of forms as both static templates and dynamic records. Initially, the form exists as a blank slate, ready to be populated with data. Once filled, it transforms into a unique document, distinct from the original empty form. This transformation highlights the form's ability to change state based on user interactions. For instance, a dentist's intake form begins as an empty template but becomes a filled document once a patient provides their information. Each filled form is a separate entity, representing the specific data provided by an individual user. However, the empty form itself remains unchanged, serving as the template for subsequent interactions. This distinction between the empty form and the filled forms underscores the versatility of forms in capturing personalized data while maintaining a consistent structure.

Some responses within the form may be classified, such as sensitive information like social security numbers or medical intake details. These classified responses are subject to access controls, ensuring that only authorized users can view or process them. This capability is crucial in scenarios involving confidential or regulated data, as it safeguards the privacy and security of the information while enabling its use in broader workflows.

A smart document is designed to ensure the integrity, authenticity, and traceability of its content and associated audit trail through the use of immutability, a global marker, and embedded intelligence. This innovative structure addresses longstanding challenges in document management, auditing, and compliance.

### Immutable Content

The content of a smart document is immutable, meaning it cannot be altered once finalized. This immutability is achieved through cryptographic techniques, such as hashing and digital signatures. When the document is created, its content is hashed to produce a unique cryptographic fingerprint. This hash is stored alongside the document and serves as a reference for verifying the integrity of the content. Any attempt to modify the content would result in a mismatch between the original hash and the hash of the altered content, immediately signaling tampering. Additionally, the document may be digitally signed using the creator's private key, ensuring that the content is not only unchangeable but also verifiable as originating from the authorized source.

### Immutable Audit Trail

The audit trail of a smart document is equally immutable. The audit trail records every interaction with the document, including access, modifications, approvals, signatures, and other events. Each event in the audit trail is cryptographically secured and timestamped, ensuring that the sequence of events is preserved and cannot be altered retroactively. For example, when a user accesses the document, the system generates a cryptographic record of the access event, including the user's identity, the time of access, and the nature of the interaction. These records are stored in a manner that prevents deletion or modification, ensuring the audit trail remains a reliable source of truth. The audit trail is also linked to the document's content, creating a unified record of both the document and its history.

### Immutable Connection to a Permanent Global Marker

Both the immutable content and the immutable audit trail are connected to an immutable global marker, which serves as the unique and unchanging identifier for the document. The global marker can be implemented as a universally unique identifier (UUID) or a cryptographic address, such as a hash-based identifier. This marker is permanent and does not change throughout the lifecycle of the document, regardless of how or where the document is accessed. The global marker ensures that the document can always be referenced and retrieved in its original form, providing a single source of truth.

The connection between the content, audit trail, and global marker is established through cryptographic linking. The global marker is embedded in the document's metadata, and the metadata itself is cryptographically secured to prevent tampering. The audit trail is also linked to the global marker, ensuring that every recorded event is associated with the correct document. This triad—immutable content, immutable audit trail, and an immutable association between the global marker and the content and audit trail—creates a robust framework that will revolutionize document management and control.

The immutability of the content, the audit trail, the global marker and of the link between the marker and the data (i.e., the content, the audit trail, and any other metadata) and the global marker, can have one or more of a variety of characteristics:

Unchangeable: Immutable refers to something that cannot be altered, modified, or edited once it has been created or finalized.

Permanent: Immutable signifies a state of permanence, where the object or data remains fixed and consistent over time.

Irreversible: Immutable describes a condition where changes are impossible, and any attempt to alter the object or data is invalid or rejected.

Fixed: Immutable means that the structure, content, or state of an object is locked and cannot be adjusted or updated.

Tamper-Proof: Immutable implies that the object or data is resistant to tampering, ensuring its integrity and authenticity.

Finalized: Immutable refers to an object or data that has reached its final form and cannot be reverted or reshaped.

Unmodifiable: Immutable describes a characteristic where the object or data is impervious to modification, whether intentional or accidental.

Consistent: Immutable ensures that the object or data remains consistent and reliable, unaffected by external influences or changes.

Secure: Immutable denotes a state of security where the object or data is safeguarded against unauthorized alterations or corruption.

Indelible: Immutable refers to something that is permanent and cannot be erased, overwritten, or replaced.

### Benefits of the Immutable Structure

Integrity: The immutability of the content ensures that the document remains unchanged and trustworthy throughout its lifecycle.

Traceability: The immutable audit trail provides a complete and verifiable history of all interactions with the document.

Authenticity: The permanent global marker guarantees that the document can always be uniquely identified and retrieved, eliminating ambiguity.

Compliance: This structure simplifies regulatory compliance by providing a reliable and tamper-proof record of the document and its history.

Interoperability: The global marker enables seamless integration with external systems, ensuring that the document can be referenced and verified across different platforms.

In summary, a smart document achieves immutability of its content and audit trail while ensuring both are immutably connected to a permanent global marker. This design provides a transformative solution for document management, offering unparalleled integrity, authenticity, and traceability.

While in some examples of smart documents the content, the audit trail, and the link to the global marker are all immutable, in other examples one of or two of these three items may be immutable. In some examples, the entirety of the content and the audit trail are immutable, and in others only a portion of the content and/or the audit trail are immutable. Furthermore, a smart document may have content and an audit trail that are immutable while having other metadata that is changeable (e.g., comments, access rights, etc.)

In addition to the foundational features of immutability, smart documents possess embedded intelligence that enables them to actively interact with their environment, respond to requests, and perform actions autonomously. This intelligence transforms the document from a static repository of information into a dynamic, interactive entity capable of understanding and adapting to its context. Embedded intelligence in smart documents is achieved through the integration of executable code, metadata, and machine-readable content, all of which work together to create a responsive and self-aware system.

### Features of Embedded Intelligence

Self-Determination and Responsiveness: Smart documents are equipped with the ability to process requests and respond dynamically. For example, when a user or system queries a document, the embedded intelligence allows the document to access its metadata, audit trail, and content to determine the appropriate response. This responsiveness is not limited to simple data retrieval; the document can also perform complex operations, such as verifying its authenticity, providing access logs, or extracting specific information from its content.

Contextual Awareness: Smart documents can understand and adapt to their context. This includes recognizing the identity of the user accessing the document, the device being used, the location of the access, and the stage of the document's lifecycle. For instance, a contract document may display different user interfaces depending on whether it is being accessed by the creator, a signatory, or a reviewer. Similarly, the document can adapt its behavior based on whether it is being accessed on a mobile device, desktop, or tablet.

Negotiation of Communication Protocols: Smart documents are capable of negotiating the manner in which they communicate with external systems. They can respond to requests using various protocols, such as RESTful APIs, gRPC, or even machine-specific languages like MCP (Machine Communication Protocol). This flexibility ensures that the document can seamlessly integrate with diverse systems and applications, making it highly interoperable.

Dynamic User Experience: The embedded intelligence enables smart documents to create personalized user experiences. For example, the document can present different panels, workflows, or visualizations depending on the user's role, the document's lifecycle stage, or the specific task being performed. This dynamic adaptability enhances usability and ensures that the document serves the needs of each stakeholder effectively.

Machine Learning and Predictive Capabilities: Smart documents can leverage machine learning algorithms to analyze their audit trail, content, and metadata to predict user needs or suggest actions. For instance, a smart document could identify patterns in user interactions and recommend next steps, such as suggesting additional documents that may be relevant to the current task or flagging anomalies in the audit trail for review.

### How Intelligence Is Embedded

The intelligence of smart documents is embedded through the integration of one or more components:

Executable Code: At the core of a smart document's intelligence is its embedded executable code. This code acts as the “brain” of the document, enabling it to process requests, perform actions, and interact with external systems. The code is designed to be lightweight and modular, allowing it to execute specific tasks efficiently without compromising the document's performance.

Metadata: Metadata provides the document with contextual information about itself, such as its creation date, owner, version history, and access permissions. This metadata is stored in a machine-readable format and is cryptographically secured to ensure its integrity. The document's intelligence uses this metadata to make decisions and respond to queries.

Machine-Readable Content: Unlike traditional documents, which are primarily human-readable, smart documents store their content in a machine-readable format. This allows the embedded intelligence to analyze the content, extract specific information, and perform operations based on the content's structure and meaning.

APIs for Interaction: Smart documents expose APIs (Application Programming Interfaces) that allow external systems to interact with them. These APIs enable the document to receive requests, process them, and return responses in a structured format, such as JSON or XML. The APIs also facilitate integration with other applications and systems, making the document highly interoperable.

Cryptographic Infrastructure: The intelligence of smart documents is underpinned by cryptographic infrastructure, which ensures the security and authenticity of the document's interactions. For example, digital signatures and hash-based identifiers are used to verify the integrity of the document and its audit trail, while encryption protects sensitive data.

Machine Learning Models: Machine learning models can be embedded within the document or accessed through external systems to enhance its intelligence. These models enable the document to analyze patterns, predict outcomes, and adapt its behavior based on historical data and real-time inputs.

### Examples of Embedded Intelligence in Action

Audit Trail Analysis: A smart document can analyze its audit trail to identify unusual patterns, such as repeated failed access attempts, and alert the owner to potential security risks.

Dynamic Rendering: When accessed on a mobile device, a smart document can automatically adjust its layout to optimize readability and usability, while providing additional features like touch-based navigation.

Workflow Management: A smart document associated with a workflow can track its progress and notify stakeholders of pending actions, such as signatures or approvals.

Content Extraction: A smart document can respond to a query by extracting specific information from its content, such as the total amount in an invoice or the number of items listed in a receipt.

Protocol Negotiation: A smart document can negotiate the format of its responses based on the preferences of the requesting system, such as providing data in JSON for web applications or XML for enterprise systems.

In summary, the embedded intelligence of smart documents is achieved through the integration of executable code, metadata, machine-readable content, APIs, cryptographic infrastructure, and machine learning models. This intelligence enables the document to interact dynamically with its environment, adapt to its context, and provide personalized experiences, making it a transformative innovation in document management.

The combination of immutability and embedded intelligence in smart documents creates a transformative paradigm for document management, offering unparalleled integrity, authenticity, traceability, and adaptability. Together, these features address longstanding challenges in document security, compliance, and usability, while enabling dynamic interactions and personalized experiences.

### The Synergy of Immutability and Embedded Intelligence

The combination of immutability and embedded intelligence creates a powerful synergy that revolutionizes document management. Immutability provides the foundation of trust, ensuring that the document's content and history are secure, authentic, and tamper-proof. Embedded intelligence builds on this foundation, enabling the document to interact dynamically with its environment, adapt to its context, and provide personalized experiences.

Enhanced Integrity and Authenticity: Immutability ensures that the document's content and audit trail remain unchanged, while embedded intelligence enables the document to verify its authenticity and respond to queries about its provenance. Together, these features create a system where trust is inherent and verifiable.

Dynamic Traceability: The immutable audit trail provides a complete history of interactions with the document, while embedded intelligence allows the document to analyze and interpret this history. This dynamic traceability enables stakeholders to understand not only what happened to the document but also why and how.

Personalized Compliance: Immutability simplifies regulatory compliance by providing a reliable and tamper-proof record of the document and its history. Embedded intelligence enhances this by adapting the document's behavior to meet specific compliance requirements, such as displaying relevant panels or workflows based on the user's role or jurisdiction.

Interoperability and Adaptability: The permanent global marker ensures seamless integration with external systems, while embedded intelligence enables the document to negotiate communication protocols and adapt its responses to different platforms. This combination ensures that the document can function effectively in diverse environments.

Predictive Security and Usability: Immutability protects the document from tampering, while embedded intelligence leverages machine learning to predict potential security risks and suggest preventive actions. This proactive approach enhances both security and usability, ensuring that the document serves the needs of its stakeholders effectively.

### Real-World Applications

The synergy of immutability and embedded intelligence has transformative implications across industries:

Legal and Compliance: Smart contracts can ensure the integrity of agreements while dynamically adapting to regulatory changes.

Finance: Immutable audit trails and intelligent analysis can enhance fraud detection and streamline reporting.

Healthcare: Patient records can remain secure and authentic while providing personalized access to authorized stakeholders.

Supply Chain: Immutable tracking and intelligent analysis can optimize logistics and ensure product authenticity.

In summary, the combination of immutability and embedded intelligence in smart documents creates a revolutionary framework for document management. By ensuring integrity, authenticity, and traceability while enabling dynamic interactions and personalized experiences, this synergy addresses longstanding challenges and unlocks new possibilities for innovation and efficiency.

### Alternative Terminology

The term “smart document” or “smart electronic document” can also be referred to as a self-determinative document, a self-tracking document, a self-assimilating document, a document with executable code, a document with embedded code, and/or in a variety of other ways depending on the context and on the features of the smart document. In some examples, a smart electronic document includes three elements, at minimum—data (e.g., content, audit trail, other metadata, etc.), executable code (e.g., an API), and a globally unique marker.

The described methods and systems provide a technical solution to the technical problem of efficiently transforming electronic documents into interactive forms while maintaining security, adaptability, and usability. Traditional approaches to document transformation rely heavily on external software tools, manual intervention, and static templates, which are resource-intensive and prone to errors. These methods fail to leverage the full capabilities of modern computing systems and networks, often resulting in inefficiencies, delays, and security vulnerabilities. By embedding intelligence directly within the electronic document, the disclosed method transforms the document into an active, self-directed entity capable of executing operations autonomously. This eliminates the need for external tools and reduces the computational overhead associated with manual processes.

The described methods and systems improve computer hardware by optimizing the use of physical processors and memory. For example, the embedded instructions within the document—such as receiving, analyzing, and converting instructions—allow the physical processor to execute tasks directly within the document, reducing the need for external processing and minimizing latency. This localized processing enhances the efficiency of the computing device, freeing up resources for other tasks and improving overall system performance. Additionally, the methods and systems leverage data storage effectively by dynamically accessing and utilizing contextual information, external data sources, and user inputs, ensuring that the document transformation process is both accurate and resource-efficient.

From a networking perspective, the methods and systems enhance the functionality of interconnected systems by enabling seamless communication and collaboration. For instance, the ability of the electronic document to operate within a networked environment allows multiple users to interact with the document simultaneously, with real-time synchronization of changes across devices. This reduces the need for fragmented copies and ensures consistency in workflows, optimizing network bandwidth usage and minimizing data redundancy. Furthermore, the integration of external systems, such as APIs and databases, allows the document to retrieve and process data dynamically, reducing the need for repetitive data transfers and improving the efficiency of network operations.

By transforming electronic documents into intelligent, self-managing entities, the methods and systems disclosed herein may address the limitations of traditional document management systems and provides a robust solution for modern computing and networking challenges. They may enhance the functionality of physical computing devices, optimize resource utilization, and improves the efficiency of networked environments, making it a significant advancement in the field of document management technologies.

In conclusion, the described system and method for dynamically transforming electronic documents into forms with read-only content and input fields provide a robust and innovative solution to the limitations of traditional document management systems. By embedding intelligence within the document itself, the invention enables autonomous operations, such as receiving user requests, analyzing contextual requirements, and executing transformations, all while maintaining security, adaptability, and efficiency. The system leverages modern computing hardware and networking capabilities to optimize resource utilization, enhance collaboration, and ensure real-time synchronization across devices. Furthermore, the integration of advanced functionalities, such as pre-filling input fields, enforcing conditions, and supporting multi-user workflows, demonstrates the versatility and scalability of the invention. This transformative approach not only streamlines workflows and reduces errors but also establishes a new paradigm for document management, making electronic documents more interactive, secure, and adaptable to diverse user needs and environments.

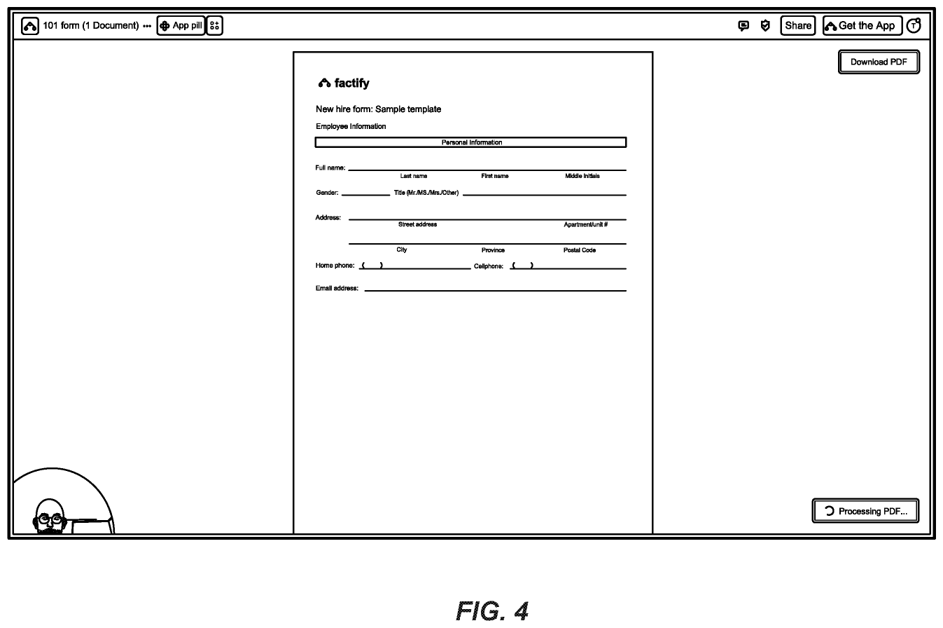

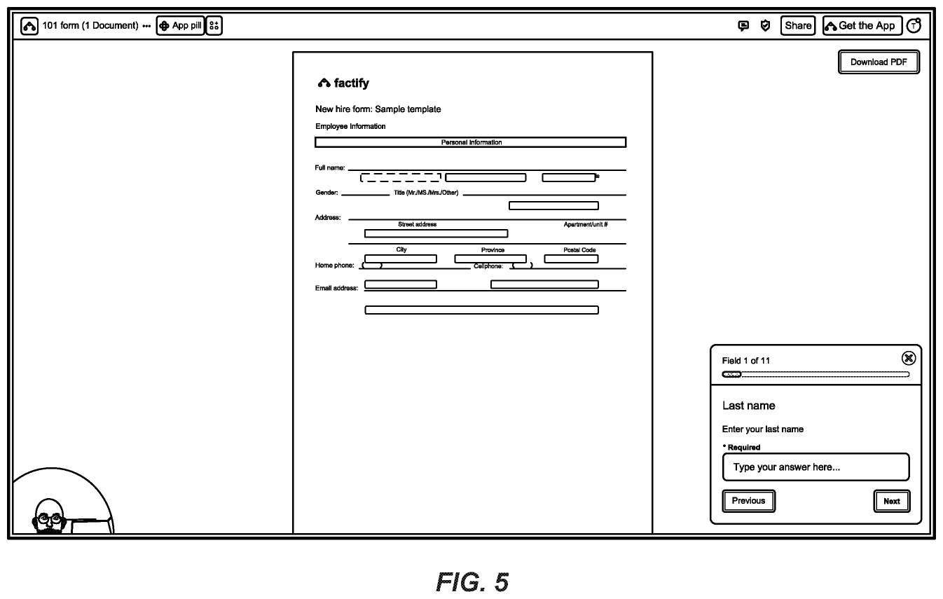

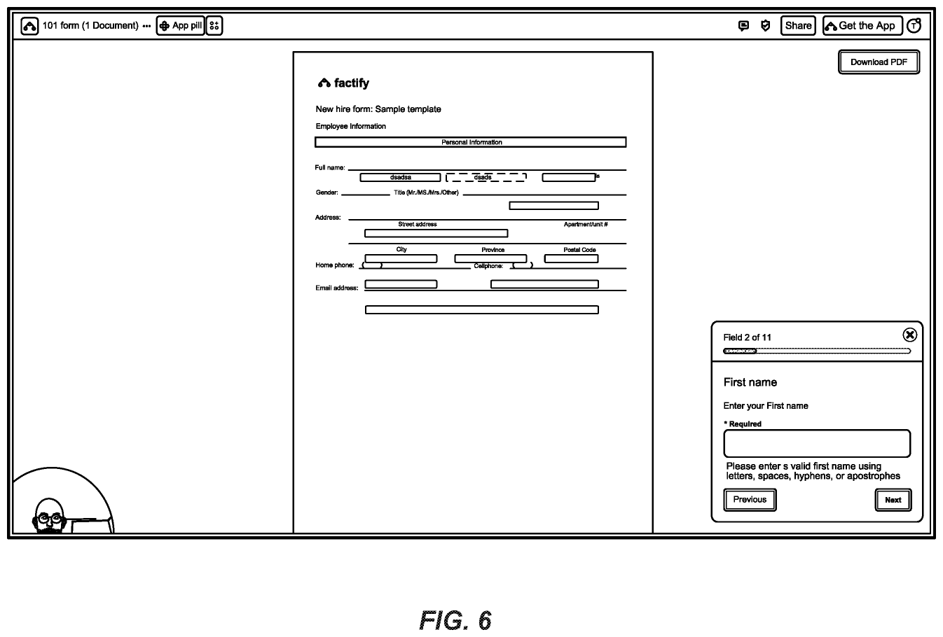

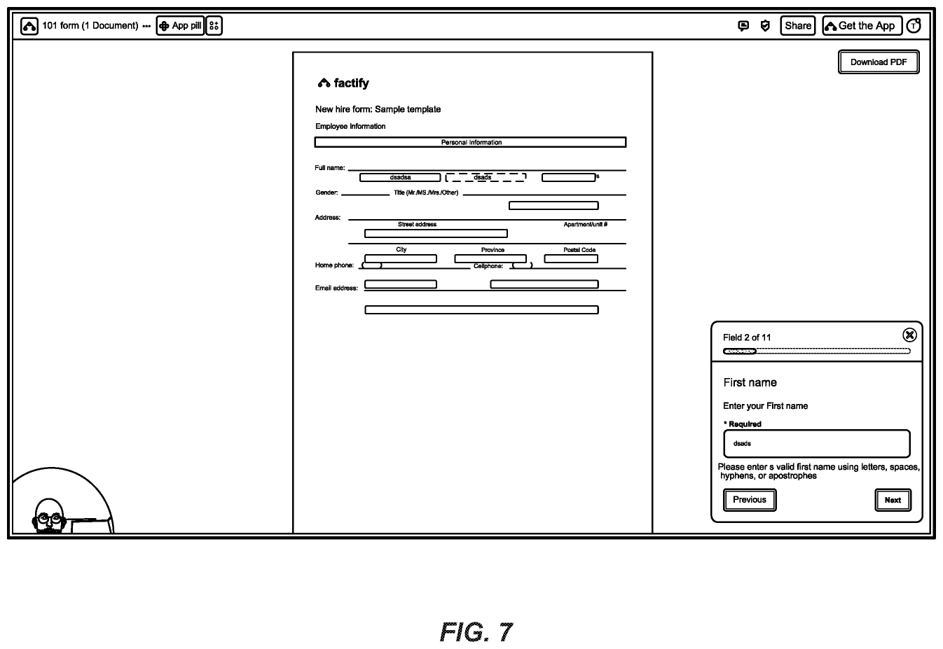

FIGS. 4-7 illustrate example user interfaces associated with transforming an electronic document into an electronic document form and receiving user input at the electronic document form according to some embodiments of this disclosure. FIG. 4 is a user interface depicting a form template presented in a viewer for processing into the electronic document form according to some embodiments of this disclosure. FIG. 5 is a user interface depicting the electronic document form with an input field for receiving user input according to some embodiments of this disclosure. FIG. 6 is a user interface depicting the electronic document form with an additional input field for receiving user input according to some embodiments of this disclosure. FIG. 7 is a user interface depicting the electronic document form with entered user input in an input field according to some embodiments of this disclosure.

Clause 1. A method comprising: receiving, at an electronic document executing on a physical processor, a request to convert the electronic document into a form having read-only content and an input field; analyzing, by the electronic document, the request; and converting, by the electronic document and based on the analysis of the request, the electronic document into the form.

Clause 2. The method of clause 1, further comprising pre-filling, by the electronic document, the input field.

Clause 3. The method of clauses 1-2, further comprising generating, by the electronic document, a link to the form.

Clause 4. The method of clauses 1-3, further comprising enabling, by the electronic document, offline filling of the input field.

Clause 5. The method of clauses 1-4, further comprising: determining, by the electronic document, that each input field of the form has been filled; and triggering, by the electronic document, a notification indicating that the form has been filled.

Clause 6. The method of clauses 1-5, further comprising: receiving, at the electronic document, a request to require that a predefined condition is met before allowing the input field to be filled; determining, by the electronic document and in response to an attempt to fill the input field, that the predefined condition has not been met; and preventing, by the electronic document, the input field from being filled.

Clause 7. The method of clauses 1-6, further comprising: receiving, at the electronic document, a request to associate a formula with the input field; associating, in response to the request and by the electronic document, the formula with the input field; and executing, in response to the input field being filled and by the electronic document, the formula.

Clause 8. The method of clauses 1-7, further comprising: receiving, at the input field and by the electronic document, input from a first user on a first device; and displaying, by the electronic document, the input from the first user on a second device of a second user.

Clause 9. The method of clauses 1-8, wherein the input field comprises a signature field; further comprising receiving, by the electronic document, a signature from a user via the signature field.

Clause 10. The method of clauses 1-9, further comprising: receiving, at the input field and by the electronic document, input from a user; and determining, by the electronic document, that the input is relevant to an additional form; and coordinating, by the electronic document; filling a field in the additional form with the input from the user.

Clause 11. The method of clauses 1-10, further comprising: identifying, by the electronic document, information from an external data source relevant to the form; and using, by the electronic document, the information from the external data source to fill the input field.

Clause 10. A system comprising: at least one physical processor; physical memory comprising computer-executable instructions that, when executed by the physical processor, cause the physical processor to: receive, at an electronic document executing on a physical processor, a request to convert the electronic document into a form having read-only content and an input field; analyze, by the electronic document, the request; and convert, by the electronic document and based on the analysis of the request, the electronic document into the form.

Clause 11. The system of clause 10, wherein the computer-executable instructions, when executed by the physical processor, further cause the electronic document to prefill the input field.

Clause 12. The system of clauses 10-11, wherein the computer-executable instructions, when executed by the physical processor, further cause the electronic document to generate, by the electronic document, a link to the form.

Clause 13. The system of clauses 10-12, wherein the computer-executable instructions, when executed by the physical processor, further cause the electronic document to enable, by the electronic document, offline filling of the input field.

Clause 14. The system of clauses 10-13, wherein the computer-executable instructions, when executed by the physical processor, further cause the electronic document to: determine that each input field of the form has been filled; and trigger a notification indicating that the form has been filled.

Clause 15. The system of clauses 10-14, wherein the computer-executable instructions, when executed by the physical processor, further cause the electronic document to: receive a request to require that a predefined condition is met before allowing the input field to be filled; determining, in response to an attempt to fill the input field, that the predefined condition has not been met; and preventing the input field from being filled.

Clause 16. The system of clauses 10-15, wherein the computer-executable instructions, when executed by the physical processor, further cause the electronic document to: receive a request to associate a formula with the input field; associate, in response to the request and by the electronic document, the formula with the input field; and execute, in response to the input field being filled and by the electronic document, the formula.

Clause 17. The system of clauses 10-16, wherein the computer-executable instructions, when executed by the physical processor, further cause the electronic document to: receive, at the input field, input from a first user on a first device; and display the input from the first user on a second device of a second user.

Clause 18. The system of clauses 10-17, wherein the input field comprises a signature field; wherein the computer-executable instructions, when executed by the physical processor, further cause the electronic document to receive a signature from a user via the signature field.

Clause 19. The system of clauses 10-18, wherein the computer-executable instructions, when executed by the physical processor, further cause the electronic document to: receive, at the input field, input from a user; and determine that the input is relevant to an additional form; and coordinate, by the electronic document; filling a field in the additional form with the input from the user.

Clause 20. The system of clauses 10-19, wherein the computer-executable instructions, when executed by the physical processor, further cause the electronic document to: identify information from an external data source relevant to the form; and use the information from the external data source to fill the input field.

Clause 21. A non-transitory computer-readable medium comprising computer-executable instructions that, when executed by at least one of one or more processors of a computing device, cause the computing device to: receive, at an electronic document executing on a physical processor, a request to convert the electronic document into a form having read-only content and an input field; analyze, by the electronic document, the request; and convert, by the electronic document and based on the analysis of the request, the electronic document into the form.

The features and clauses discussed herein may provide one or more of the advantages and/or solutions described, such as enhancing security, improving operational efficiency, or enabling dynamic access control. Additionally, these features and clauses may offer further or alternative benefits or address further or alternative challenges beyond those explicitly mentioned. The disclosed features and clauses are not limited to the specific advantages or solutions described and may be implemented in various ways to achieve additional or alternative benefits and/or solutions.

As detailed above, the computing devices and systems described and/or illustrated herein broadly represent any type or form of computing device or system capable of executing computer-readable instructions, such as those contained within the modules described herein. In their most basic configuration, these computing device(s) may each include at least one memory device and at least one physical processor.

In some examples, the term “memory device” generally refers to any type or form of volatile or non-volatile storage device or medium capable of storing data and/or computer-readable instructions. In one example, a memory device may store, load, and/or maintain one or more of the modules described herein. Examples of memory devices include, without limitation, Random Access Memory (RAM), Read Only Memory (ROM), flash memory, Hard Disk Drives (HDDs), Solid-State Drives (SSDs), optical disk drives, caches, variations or combinations of one or more of the same, or any other suitable storage memory.

In some examples, the term “physical processor” generally refers to any type or form of hardware-implemented processing unit capable of interpreting and/or executing computer-readable instructions. In one example, a physical processor may access and/or modify one or more modules stored in the above-described memory device. Examples of physical processors include, without limitation, microprocessors, microcontrollers, Central Processing Units (CPUs), Field-Programmable Gate Arrays (FPGAs) that implement softcore processors, Application-Specific Integrated Circuits (ASICs), portions of one or more of the same, variations or combinations of one or more of the same, or any other suitable physical processor.

Although illustrated as separate elements, the modules described and/or illustrated herein may represent portions of a single module or application. In addition, in certain embodiments one or more of these modules may represent one or more software applications or programs that, when executed by a computing device, may cause the computing device to perform one or more tasks. For example, one or more of the modules described and/or illustrated herein may represent modules stored and configured to run on one or more of the computing devices or systems described and/or illustrated herein. One or more of these modules may also represent all or portions of one or more special-purpose computers configured to perform one or more tasks.

In addition, one or more of the modules described herein may transform data, physical devices, and/or representations of physical devices from one form to another. Additionally or alternatively, one or more of the modules recited herein may transform a processor, volatile memory, non-volatile memory, and/or any other portion of a physical computing device from one form to another by executing on the computing device, storing data on the computing device, and/or otherwise interacting with the computing device.

In some embodiments, the term “computer-readable medium” generally refers to any form of device, carrier, or medium capable of storing or carrying computer-readable instructions. Examples of computer-readable media include, without limitation, transmission-type media, such as carrier waves, and non-transitory-type media, such as magnetic-storage media (e.g., hard disk drives, tape drives, and floppy disks), optical-storage media (e.g., Compact Disks (CDs), Digital Video Disks (DVDs), and BLU-RAY disks), electronic-storage media (e.g., solid-state drives and flash media), and other distribution systems.

The process parameters and sequence of the steps described and/or illustrated herein are given by way of example only and can be varied as desired. For example, while the steps illustrated and/or described herein may be shown or discussed in a particular order, these steps do not necessarily need to be performed in the order illustrated or discussed. The various exemplary methods described and/or illustrated herein may also omit one or more of the steps described or illustrated herein or include additional steps in addition to those disclosed.

The preceding description has been provided to enable others skilled in the art to best utilize various aspects of the exemplary embodiments disclosed herein. This exemplary description is not intended to be exhaustive or to be limited to any precise form disclosed. Many modifications and variations are possible without departing from the spirit and scope of the present disclosure. The embodiments disclosed herein should be considered in all respects illustrative and not restrictive. Reference should be made to the appended claims and their equivalents in determining the scope of the present disclosure.

Unless otherwise noted, the terms “connected to” and “coupled to” (and their derivatives), as used in the specification and claims, are to be construed as permitting both direct and indirect (i.e., via other elements or components) connection. In addition, the terms “a” or “an,” as used in the specification and claims, are to be construed as meaning “at least one of.” Finally, for ease of use, the terms “including” and “having” (and their derivatives), as used in the specification and claims, are interchangeable with and have the same meaning as the word “comprising.”

What is claimed is:

1. A method comprising:
receiving, at an electronic document executing on a physical processor, a request to convert the electronic document into an electronic document form having read-only content and an input field;
analyzing, by the electronic document, the request; and
converting, by the electronic document and based on the analysis of the request, the electronic document into the electronic document form.

2. The method of claim 1, further comprising pre-filling, by the electronic document, the input field.

3. The method of claim 1, further comprising generating, by the electronic document, a link to the electronic document form.

4. The method of claim 1, further comprising enabling, by the electronic document, offline filling of the input field.

5. The method of claim 1, further comprising:
determining, by the electronic document, that each input field of the electronic document form has been filled; and
triggering, by the electronic document, a notification indicating that the electronic document form has been filled.

6. The method of claim 1, further comprising:
receiving, at the electronic document, a request to require that a predefined condition is met before allowing the input field to be filled;
determining, by the electronic document and in response to an attempt to fill the input field, that the predefined condition has not been met; and
preventing, by the electronic document, the input field from being filled.

7. The method of claim 1, further comprising:
receiving, at the electronic document, a request to associate an electronic document formula with the input field;
associating, in response to the request and by the electronic document, the formula with the input field; and
executing, in response to the input field being filled and by the electronic document, the formula.

8. The method of claim 1, further comprising:
receiving, at the input field and by the electronic document, input from a first user on a first device; and
displaying, by the electronic document, the input from the first user on a second device of a second user.

9. The method of claim 1,
wherein the input field comprises a signature field;
further comprising receiving, by the electronic document, a signature from a user via the signature field.

10. The method of claim 1, further comprising:
receiving, at the input field and by the electronic document, input from a user; and
determining, by the electronic document, that the input is relevant to an additional electronic document form; and
coordinating, by the electronic document; filling a field in the additional electronic document form with the input from the user.

11. The method of claim 1, further comprising:
identifying, by the electronic document, information from an external data source relevant to the electronic document form; and
using, by the electronic document, the information from the external data source to fill the input field.

12. The method of claim 1, wherein the electronic document is configured to negotiate communication with an external system using a machine communication protocol (MCP).

13. The method of claim 1, further comprising analyzing, by the electronic document, its audit trail using an embedded machine learning model to identify unusual patterns in user interactions and to generate an alert.

14. The method of claim 1, wherein the electronic document exposes an application programming interface configured to return responses in a structured format selected from JSON or XML.

15. The method of claim 1, wherein the electronic document adapts its user interface based on contextual information comprising at least one of user identity, device type, location, or a lifecycle stage of the electronic document.

16. The method of claim 1, further comprising extracting, by the electronic document, specific information from its content in response to a query.

17. The method of claim 1, wherein the electronic document comprises embedded executable code configured to autonomously process requests and perform actions without reliance on external tools.

18. The method of claim 1, further comprising providing, by the electronic document, personalized panels or workflows based on a role of a user accessing the electronic document.

19. The method of claim 1, further comprising verifying, by the electronic document, integrity of its content by calculating a cryptographic hash of the content and comparing the calculated hash with a hash stored in metadata of the electronic document.

20. A system comprising:
at least one physical processor;
physical memory comprising computer-executable instructions that, when executed by the physical processor, cause the physical processor to:
receive, at an electronic document executing on a physical processor, a request to convert the electronic document into an electronic document form having read-only content and an input field;
analyze, by the electronic document, the request; and
convert, by the electronic document and based on the analysis of the request, the electronic document into the electronic document form.

21. The system of claim 20, wherein the computer-executable instructions, when executed by the physical processor, further cause the electronic document to prefill the input field.

22. The system of claim 20, wherein the computer-executable instructions, when executed by the physical processor, further cause the electronic document to generate, by the electronic document, a link to the electronic document form.

23. The system of claim 20, wherein the computer-executable instructions, when executed by the physical processor, further cause the electronic document to enable, by the electronic document, offline filling of the input field.

24. The system of claim 20, wherein the computer-executable instructions, when executed by the physical processor, further cause the electronic document to:
determine that each input field of the electronic document form has been filled; and
trigger a notification indicating that the electronic document form has been filled.

25. The system of claim 20, wherein the computer-executable instructions, when executed by the physical processor, further cause the electronic document to:
receive a request to require that a predefined condition is met before allow the input field to be filled;
determining, in response to an attempt to fill the input field, that the predefined condition has not been met; and
preventing the input field from being filled.

26. The system of claim 20, wherein the computer-executable instructions, when executed by the physical processor, further cause the electronic document to:
receive a request to associate a formula with the input field;
associate, in response to the request and by the electronic document, the formula with the input field; and
execute, in response to the input field being filled and by the electronic document, the formula.

27. The system of claim 20, wherein the computer-executable instructions, when executed by the physical processor, further cause the electronic document to:
receive, at the input field, input from a first user on a first device; and
display the input from the first user on a second device of a second user.

28. The system of claim 20,
wherein the input field comprises a signature field;
wherein the computer-executable instructions, when executed by the physical processor, further cause the electronic document to receive a signature from a user via the signature field.

29. The system of claim 20, wherein the computer-executable instructions, when executed by the physical processor, further cause the electronic document to:
receive, at the input field, input from a user; and
determine that the input is relevant to an additional electronic document form; and
coordinate, by the electronic document; filling a field in the additional electronic document form with the input from the user.

30. The system of claim 20, wherein the computer-executable instructions, when executed by the physical processor, further cause the electronic document to:
identify information from an external data source relevant to the electronic document form; and
use the information from the external data source to fill the input field.

31. A non-transitory computer-readable medium comprising computer-executable instructions that, when executed by at least one of one or more processors of a computing device, cause the computing device to:
receive, at an electronic document executing on a physical processor, a request to convert the electronic document into an electronic document form having read-only content and an input field;
analyze, by the electronic document, the request; and
convert, by the electronic document and based on the analysis of the request, the electronic document into the electronic document form.
